(19) United States
(12) Patent Application Publication
(10) Pub. No.: US 2006/0209114 A1
(43) Pub. Date: Sep. 21, 2006

(54) Paper sheet delivery control and inkjet type image-forming apparatus

(76) Inventor: Kazunori Namai, Ibaraki (JP)

Correspondence Address: DELLETT & WALTERS, P. O. BOX 82788, PORTLAND, OR, 97282-0788, US

(21) Appl. No.: 11/357,924

(22) Filed: Feb. 17, 2006

(30) Foreign Application Priority Data
Feb. 21, 2005 (JP) 2005-043397
Dec. 1, 2005 (JP) 2005-347812

(51) Int. Cl. B41J 29/38

(52) U.S. Cl. 347/16

(57) ABSTRACT

In multi-passage inkjet printing of an image for detecting the deviation of recording medium by changing the angle of stepwise rotation, the formed image can have a black streak or a white streak visually observable depending on the stepwise rotation angle, as shown in the drawings (a) to (g) in FIG. 28. In FIG. 28, at the rotation angle of 87°, neither a black streak nor a white streak was observed visually (FIG. 28(b)). This rotation angle causing no streak is named an optimum rotation angle. The deviation of the paper sheet delivery distance (or occurrence of a black or white streak) depends on the extent of deviation of the de-centered rotation axis D (depending on the position of the center axis D) from the designed center axis C.

### TECHNICAL FIELD

The present invention relates to a method for controlling the delivery rate (stepwise delivery distance) of a paper sheet, and to an inkjet type image-forming apparatus employing this method for controlling the paper sheet delivery.

### BACKGROUND TECHNIQUE

Inkjet type image-forming apparatuses are known which form an image by ejecting ink onto a recording medium like a recording paper sheet, as an output apparatus of a computer or a work station. The inkjet type image-forming apparatus has usually a recording head (printing head), a carriage supporting the recording head and reciprocating in a predetermined direction (a main scanning direction), and a recording-medium-feeding assembly. The recording head has plural nozzles which are aligned in a line (or lines) in the recording medium feed direction. The distance between the both ends of the nozzle line is hereinafter referred to as an entire nozzle breadth.

Before development of a multi-passage printing method for formation of an image on a recording medium, a recording medium is delivered (fed) by the distance (portion) of the entire nozzle breadth, and is stopped temporarily. Thereon, a band portion of an image is formed in the image formation region facing to the nozzle outlets (ink ejection openings) in the entire nozzle breadth by reciprocating once the carriage in the aforementioned main scanning direction and ejecting an ink in accordance with image signals (image data) carrying an image information. Then the recording medium sheet is delivered by the distance of the entire nozzle breadth and is stopped, and again the ink is ejected through the nozzles of the recording head in accordance with the image data by reciprocating once the carriage in the main scanning direction on the next portion of the image formation region of the recording medium. The entire image is formed on the recording medium by repeating the above operation.

In this method, however, the distance of the stepwise delivery of the recording medium (paper sheet feed) can deviate from the intended entire nozzle breadth owing to variation in production of the parts incorporated in the inkjet type image-forming apparatus. In formation of a band portion of an image in the entire nozzle breadth by a stepwise delivery of the recording medium sheet by the entire nozzle breadth as mentioned above (by one reciprocation of the recording head in the main scanning direction), deviation of the formed image will not occur insofar as the delivery distance of the recording medium in one delivery step is precisely equal to the entire nozzle breadth. However, when the distance of the delivery of the recording medium is shorter than the entire nozzle breadth, a part of the image having been formed can overlap with a part of the subsequently formed image at the boundary to give a black streak. Conversely, when the distance of the delivery of the recording medium is longer than the entire nozzle breadth, a gap can be produced between the image having been formed and the subsequently formed image to give a white streak. To prevent the black streak or white streak, a multi-passage printing is proposed.

Lately, the image resolution of the inkjet type image-forming apparatus is becoming finer, and the apparatus is constituted to be capable of adjusting more precisely the delivery rate of the recording medium. Consequently, the user himself should adjust the recording medium delivery rate by utilizing a printed test pattern for detection of delivery deviation (variation of the delivery distance) every time when the recording head or recording medium is replaced. The adjustment should be finer for the fine resolution. For example, the delivery adjustment range, which is conventionally from one dot to ½ dot, has been improved to be about 1/7 dot. However, with the apparatus capable of such fine delivery adjustment, it is not easy for the user to find the optimum adjustment level by printing a test pattern for detecting the delivery deviation, and the selection of the adjustment level may be not precise. To solve this difficulty, a technique is disclosed for detecting readily the deviation of the recording medium delivery distance (e.g., Japanese Patent Application Laid-Open No. 2004-47526). This technique makes it possible to detect readily the sheet delivery deviation by magnifying the deviation by forming images: for example, detection by the regions 1-1 and 4-4 adjacent to each other in the first band by different passage as shown in FIG. 5 or FIG. 6.

The technique disclosed in the aforementioned Japanese Patent Application Laid-Open No. 2004-47526 is effective for correcting the deviation of the delivery distance (deviation from the designed stepwise delivery distance), insofar as the deviation of the delivery distance is constant. Here, the constancy of the deviation of the delivery distance signifies that, in the first to fourth bands in FIGS. 5 and 6, the deviation is constant. Actually, however, the deviation of the stepwise delivery distance of the recording medium is not constant: a delivery distance (e.g., in the first passage) and the subsequent delivery distance (e.g., in the second passage) can be different. The difference signifies that, in FIGS. 5 and 6, the deviation of the breadth d of the first band and the deviation of the breadth d of the fourth band are not equal to each other.

The cause of the difference (variation) of the delivery distance is explained below.

The recording medium delivery assembly has generally a delivery roller 24 (FIG. 1) for delivering a recording medium by direct contact with it. This delivery roller 24 is rotated by a stepping motor or the like to deliver the recording medium stepwise by a designed distance. However, the delivery roller 24 may be eccentric owing to an allowable tolerance of the recording medium-delivery assembly. The eccentric rotation of the delivery roller 24 can cause variation of the delivery distance of the recording medium in every delivery step (one passage) to cause the aforementioned difference of the successive delivery distance or the variation of the delivery distance.

The technique disclosed in the above Japanese Patent Application Laid-Open No. 2004-47526 assumes that the deviation of the stepwise delivery distance is constant, so that the technique can be effective to correct the deviation of the delivery distance only when the delivery distance is constant.

### DISCLOSURE OF THE INVENTION

Under the aforementioned circumstance, the present invention intends to provide a method for adjusting the distance of the recording medium delivery regardless of variation of deviation of the distance of the recording medium (paper sheet delivery distance), and to provide also an inkjet type image-forming apparatus employing the method for adjusting the distance of paper sheet delivery.

For achieving the above object, according to the method for adjusting the distance of the recording medium delivery of the present invention, an image is formed in one band on a recording medium sheet by three or more multiple passage printing; wherein

(1) printing is conducted by passages on first plural sub-regions (sub-region group) aligned in the paper sheet delivery direction in the one band, and further printing is conducted, by passages different from the passage for the first plural sub-regions, on second plural sub-regions adjacent to the first plural sub-regions in the main scanning direction perpendicular to the paper sheet delivery direction; and

(2) the paper sheet delivery distance is adjusted based on the images formed in the first plural sub-regions and the second plural sub-regions.

(3) In printing on the first plural sub-regions by different passages, printing may be conducted on one sub-region of the plural sub-regions by a passage preceding the passage for the adjacent other sub-region by two or more passages.

(4) In printing on the second plural sub-regions by different passages, printing may be conducted on one of the sub-regions by a passage preceding the passage for the adjacent other sub-region by two or more passages.

(5) On the one sub-region of the first plural sub-regions, the printing may be conducted by a passage different from the passage for printing on one sub-region of the second plural sub-regions. Further,

(6) on the other sub-region of the first plural sub-regions, the printing may be conducted by a passage different from the passage for printing on the other sub-region of the second plural sub-regions.

(7) By the method, the inkjet image-forming apparatus may be the one which repeats an image-forming operation of delivering a recording medium sheet by a distance of one band breadth in the sheet delivery direction and stopping the sheet delivery, and forming an image by ejection of an ink from a recording head scanning in the scanning direction perpendicular to the sheet delivery direction.

(8) The first plural sub-regions may be formed by dividing the one band into three or more in the sheet delivery direction and are aligned in the sheet delivery direction.

(9) The first plural sub-regions may be formed by dividing equally the one band in the sheet delivery direction.

(10) The second plural sub-regions may be formed by dividing the one band into two or more in the main scanning direction, aligned in the main scanning direction.

(11) The second plural sub-regions may be formed by dividing equally the one band in the main scanning direction.

(12) In forming an image in the first and second plural sub-regions, the image is formed in the first and second plural sub-regions by delivering the recording medium sheet by changing the sheet delivery distance in several distance levels.

(13) The adjustment images at different intervals mentioned in the item (14) below may be formed by printing plural adjustment patterns by changing the delivery distance, and the paper sheet delivery distance may be adjusted based on the adjustment patterns.

An inkjet type image-forming apparatus of the present invention for achieving the above object is the one which records an image on a recording medium sheet by ejecting an ink from a recording head held on a carriage by scanning with the recording head; delivering, after recording of one line of the image, a recording medium sheet by a prescribed distance; repeating the recording for formation of an entire image:

(14) wherein the delivery distance of the recording medium sheet is controlled by using a mask for print-adjustment images at different intervals in the recording medium sheet delivery direction.

Another inkjet type image-forming apparatus of the present invention to achieve the above object for forming an image in one band of a recording medium by multi-passage printing of three or more passages,

(15) wherein the apparatus is equipped with a recording head-controlling means which controls the recording head to conduct printing on the first plural sub-regions adjacent to each other in the recording medium delivery direction, and to conduct printing on the second plural sub-regions adjacent to the first plural sub-regions in the main scanning direction perpendicular to the recording medium sheet delivery direction by passages being different by at least one passage from the passage employed in the printing on the first sub-regions.

The recording head controlling means

(16) may control, in printing on the first plural sub-regions by different passages, the recording head to conduct printing on one sub-region of the plural sub-regions by a passage preceding the passage for the adjacent other sub-region by two or more passages.

(17) The recording head controlling means may control, in printing on the second plural sub-regions by different passages, the recording head to conduct printing on one sub-region of the plural sub-regions by a passage preceding the passage for the adjacent other sub-regions by two or more passages.

The recording head-controlling means

(18) may control the recording head to conduct printing, on one sub-region of the first plural sub-regions, by a passage different from the passage for printing on the one sub-region of the second plural sub-regions.

Further, the recording head controlling means

(19) may control the recording head to conduct printing, on the other sub-region of the first plural sub-regions, by a passage different from the passage for printing on the other sub-region of the second plural sub-regions.

Further, the first plural sub-regions

(20) may be formed by dividing the one band into three or more in the sheet delivery direction and are aligned in the sheet delivery direction.

Further, the first plural sub-regions

(21) may be formed by dividing equally the one band in the sheet delivery direction.

Further, the second plural sub-regions

(22) may be formed by dividing the one band into two or more in the main scanning direction, aligned in the main scanning direction.

Further, the second plural sub-regions

(23) may be formed by dividing equally the one band in the main-scanning direction.

Further, in forming an image in the first and second plural sub-regions,

(24) the image is formed in the first and second plural sub-regions by delivering the recording medium sheet by changing the sheet delivery distance in several distance levels.

### BRIEF DESCRIPTION OF THE DRAWINGS

FIG. 1 is a perspective drawing illustrating schematically a constitution of an inkjet type plotter.

FIG. 2 is a block diagram showing an electric system of the plotter shown in FIG. 1.

FIG. 3 shows a completed print, the symbol “a” indicating a printed dot.

FIG. 4 explains a process for printing the completed print shown in FIG. 3, an example of 4-passage printing.

In FIG. 5, the drawings in the series (a) (vertical series) explain schematically the positional relation between the recording medium and the recording head, and the drawings in the series (b) explain the regions of an image formed on a recording medium by recording heads. The terms “first passage” to “fourth passage” indicate the order of scanning by a nozzle group for formation of the image on a recording medium.

FIG. 6 is continuation of FIG. 5. The drawings in the series (a) explain schematically the positional relation between the recording medium and the recording head, and the drawings in the series (b) explain the regions of an image formed on a recording medium by recording heads. The terms “fifth passage” to “seventh passage” indicate the order of scanning by a nozzle group for formation of the image on a recording medium after the fourth passage in FIG. 5.

FIG. 7 illustrates schematically deviation of the paper delivery distance. The top drawing shows the correct printed image, and the lower drawings show the state of deviation of the paper delivery distance.

In FIG. 8, the drawings at the left side shows schematically printing for confirmation at an adjustment level of zero, and the drawings at the right side show schematically printing for confirmation at an adjustment level of +1 for the optimum correction.

FIG. 9 illustrates schematically deviation of the paper delivery distance with an eccentric delivery roller.

FIG. 10 is a drawing for explaining a method of adjusting the paper sheet delivery distance for an eccentric delivery roller.

FIG. 11 is a drawing for explaining the relation between the mask for confirmation of paper sheet delivery and the delivery roller in a comparative example.

FIG. 12 is a drawing for explaining the relation between the mask for confirmation of paper sheet delivery and the delivery roller in the present invention.

FIG. 13 is a drawing for explaining the printing mask for confirmation of the paper sheet delivery in the example.

FIG. 14 illustrates deviation of paper sheet delivery distance under magnification.

FIG. 15 illustrates schematically a rotation state of a delivery roller.

FIG. 16 is a plan view illustrating schematically a positional relation of a recording medium and a recording head immediately before start of rotation of a delivery roller. The symbol PC denotes a recording medium to be delivered by a roller having a rotation axis C: The symbol PD denotes a recording medium to be delivered by a roller having an eccentric rotation axis D.

FIG. 17 is a plan view illustrating schematically a positional relation of the recording mediums PC and PD and the recording head at the instant when the delivery roller has been turned at a first ¼ rotation.

FIG. 18 is a plan view illustrating schematically a positional relation of the recording mediums PC and PD and the recording head at the instant when the delivery roller has been turned at a second ¼ rotation.

FIG. 19 is a plan view illustrating schematically a positional relation of the recording mediums PC and PD and the recording head at the instant when the delivery roller has been turned at a third ¼ rotation.

FIG. 20 is a plan view illustrating schematically a positional relation of the recording mediums PC and PD and the recording head at the instant when the delivery roller has been turned at a fourth ¼ rotation.

FIG. 21 illustrates schematically an example of nozzle groups of a recording head.

FIG. 22 illustrates schematically sub-regions, smaller divisions of the one band region, for adjustment of the delivery distance.

FIG. 23 shows the recording head and the recording medium at the positions corresponding to FIG. 16.

FIG. 24 shows the recording head and the recording medium at the positions corresponding to FIG. 17. The images formed as an indicator for delivery distance adjustment is shown by oblique lines.

FIG. 25 shows the recording head and the recording medium at the positions corresponding to FIG. 18. The images formed as an indicator for delivery distance adjustment are shown by oblique lines or parallel lines.

FIG. 26 shows the recording head and the recording medium at the positions corresponding to FIG. 19. The images formed as an indicator for delivery distance adjustment are shown by oblique lines or parallel lines.

FIG. 27 shows the recording head and the recording medium at the positions corresponding to FIG. 20. The images formed as an indicator indexes for delivery distance adjustment are shown by oblique lines or parallel lines.

FIG. 28 shows examples of images printed for inspection of deviation of the paper sheet delivery distance by changing the central rotation angle of the stepwise rotation by 1° from 86° to 92°: the rotation angles of the central axis D being: (a), 86°; (b), 87°; (c), 88°; (d), 89°; (e), 90°; (f), 91°; and (g), 92° in FIG. 28.

### BEST MODE FOR CARRYING OUT THE INVENTION

The present invention has been realized in a plotter for forming an image on a rolled paper sheet.

### EXAMPLE 1

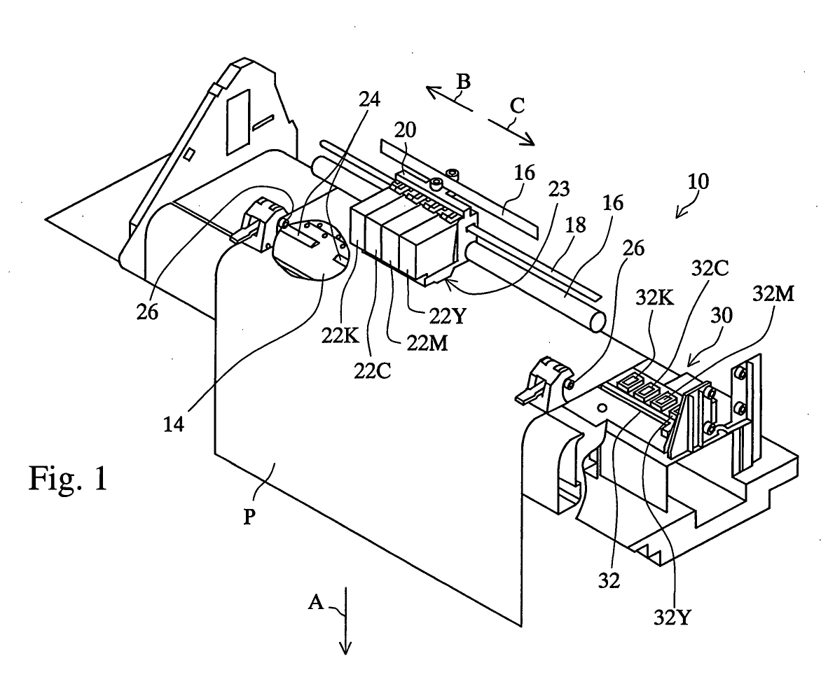

An example of a plotter of the inkjet type image-forming apparatus of the present invention is explained by reference to FIG. 1.

FIG. 1 is a perspective drawing illustrating schematically a constitution of an inkjet type plotter.

The plotter 10 is equipped with a platen 14. A rolled paper sheet 12 (an example of the recording medium in the present invention) is placed thereon and is delivered in the arrow-A direction (paper feed direction). Above the platen 14, two parallel scanning rails (guide rails) 16 are spanned parallel to the platen 14. Onto the scanning rails 16, a carriage 20 is mounted through a bearing slider (not shown in the drawing). This carriage 20 is driven (allowed to scan) in reciprocation by a motor (not shown in the drawing) and an endless belt 18 in the arrow-B direction and the arrow-C direction (the directions being perpendicular to the arrow-A direction, an example of the main scanning direction).

The carriage 20 holds four recording heads 22K (black), 22C (cyan), 22M (magenta), and 22Y (yellow) having respectively ink-ejection openings (outlets of nozzles, not shown in the drawing). The front side of the ink-ejection openings is the image formation region 23 for formation of an image. Inks are ejected through the ink-ejection openings onto the portion of a rolled paper sheet P placed in the image formation region 23 to form an image.

At a position outside the image formation region 23 within the movement range of the carriage 20, a recovery device 30 is provided which recovers the original ejection state of the ink supply paths and nozzles of the recording heads 22K, 22C, 22M, and 22Y by sucking forcedly the inks from the nozzles.

The recovery device 30 has four rubber caps 32K, 32C, 32M, and 32Y for capping respectively the ejection outlets of the four recording heads 22K, 22C, 22M, and 22Y. A sucking tube (not shown in the drawing) is connected to each of the caps 32K, 32C, 32M, and 32Y. The other ends of the ink-sucking tubes are connected to a sucking pump (not shown in the drawing). The four caps 32K, 32C, 32M, and 32Y are fixed to a cap holder 32.

For formation of an image on a recording medium like a rolled paper sheet, a portion of the rolled paper sheet P is placed on the platen 14, the rolled paper sheet is pinched by a delivery roller 24 having peripheral face exposed partly through openings (not shown in the drawing) of the platen 14 and a pinch roller 26, and the rolled paper sheet P is delivered by driving the delivery roller 24 by a delivery motor (not shown in the drawing). The carriage 20 is allowed to reciprocate in the direction of the arrows B and C across the rolled paper sheet, and the inks are ejected through the nozzles in accordance with the image signals carrying image information transmitted from the head control assembly to the recording heads 22K, 22C, 23M, and 22Y to form an image in the portion in the image formation region 23.

After completion of the image formation, the rolled paper sheet P is cut in a prescribed size by allowing a cutter (not shown in the drawing) held by the carriage 20 to protrude to a predetermined position. During the image formation operation, when the nozzle needs to be cleaned by sucking of the ink from the nozzle, the carriage 20 is moved to a position above the recovery device 30.

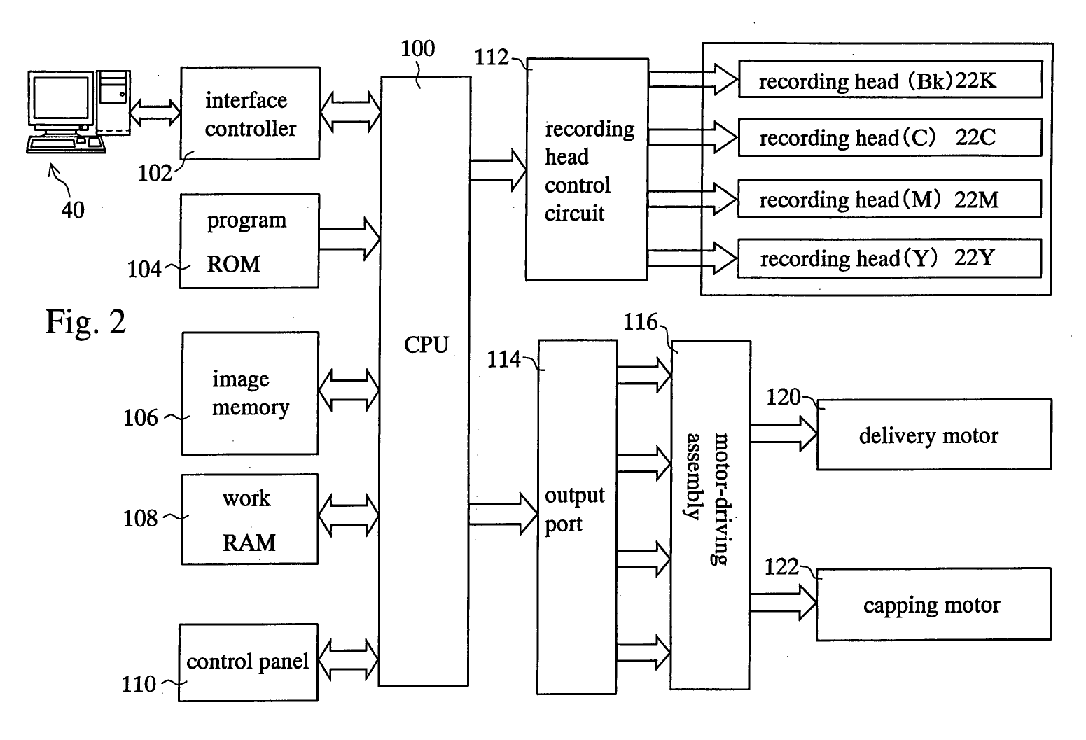

The electric system of the plotter 10 is explained by reference to FIG. 2.

FIG. 2 is a block diagram of an electric system of the plotter shown in FIG. 1.

The recorded data or command transmitted from a host PC 40 is introduced through an interface controller 102 to a CPU 100. The CPU 100 is an arithmetic processing unit for general control, including reception of recorded data for the plotter 10, recording operation, and handling of the rolled paper sheet P. The CPU 100 analyzes the received command, and develops the color components of the recorded data to a bit-map in an image memory 106 for image formation. Before the recording, the recording heads 22K, 22C, 22M, and 22Y are moved apart from a recovery device 30 to a recording region (image formation region) by driving a capping motor 122 through an output port 114 and a motor-driving assembly 116.

Then a roll motor (not shown in the drawing) for sending out a rolled paper sheet P (FIG. 1) through an output port 114 and a motor-driving assembly 116 and a delivery roller 120 for delivering the rolled paper sheet P at a low delivery speed are driven to deliver the rolled paper sheet P to the recording region. The timing of start of ink ejection onto the rolled paper sheet P (timing for recording) is decided by detection of the front edge of the rolled paper sheet P by a front edge detector. After that, the CPU 100 reads out the corresponding color record data successively from the image memory 106. The read-out data are transmitted through a recording head-controlling circuit 112 (an example of the recording head-controlling means in the present invention) to the respective recording heads 22K, 22C, 22M, and 22Y.

The CPU 100 is operated according to a treatment program memorized in a program ROM 104. This program ROM 104 memorizes treatment programs and tables corresponding to the control flow. A work RAM 108 is employed as the memory for the operation. The recording heads 22K, 22C, 22M, and 22Y conduct the multi-passage printing by control with a control circuit 112.

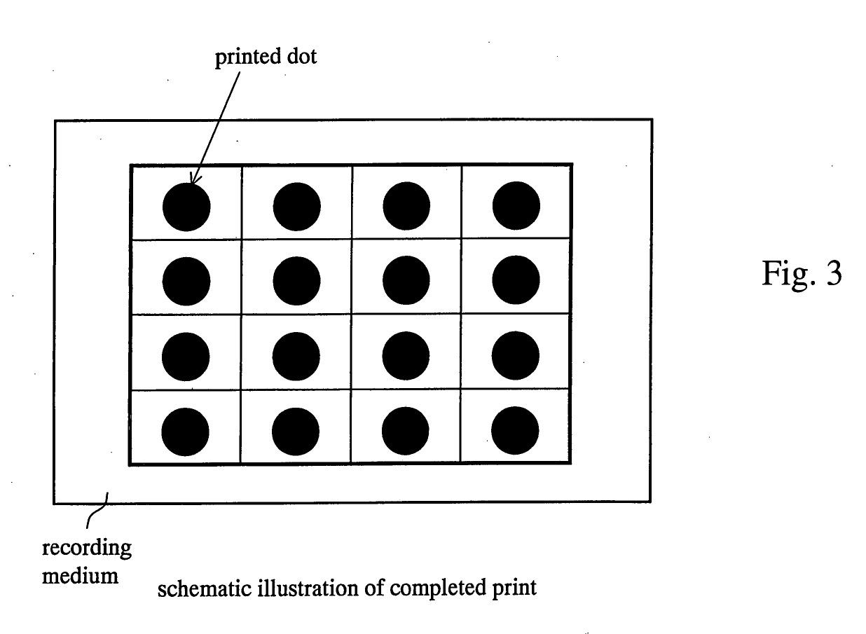

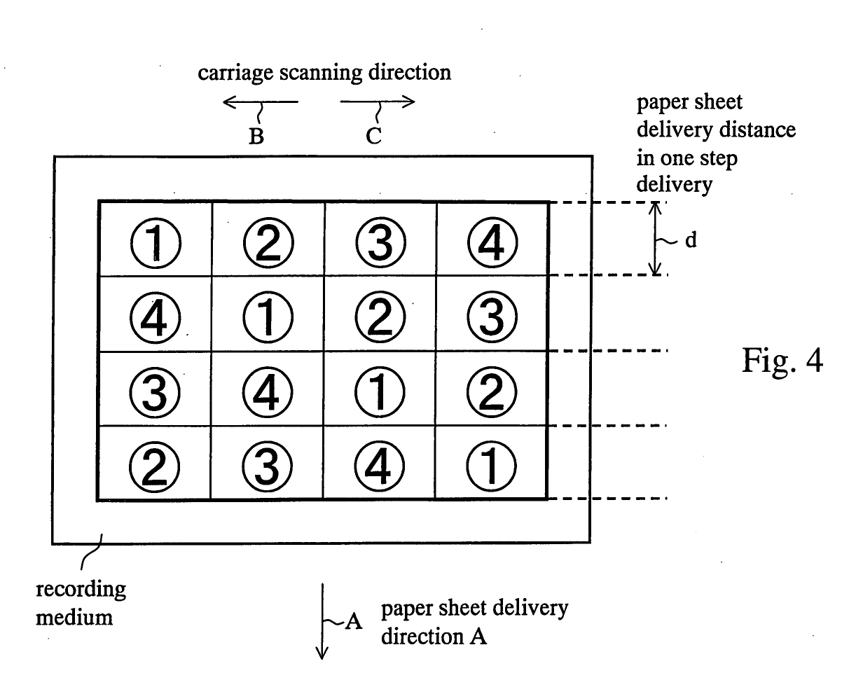

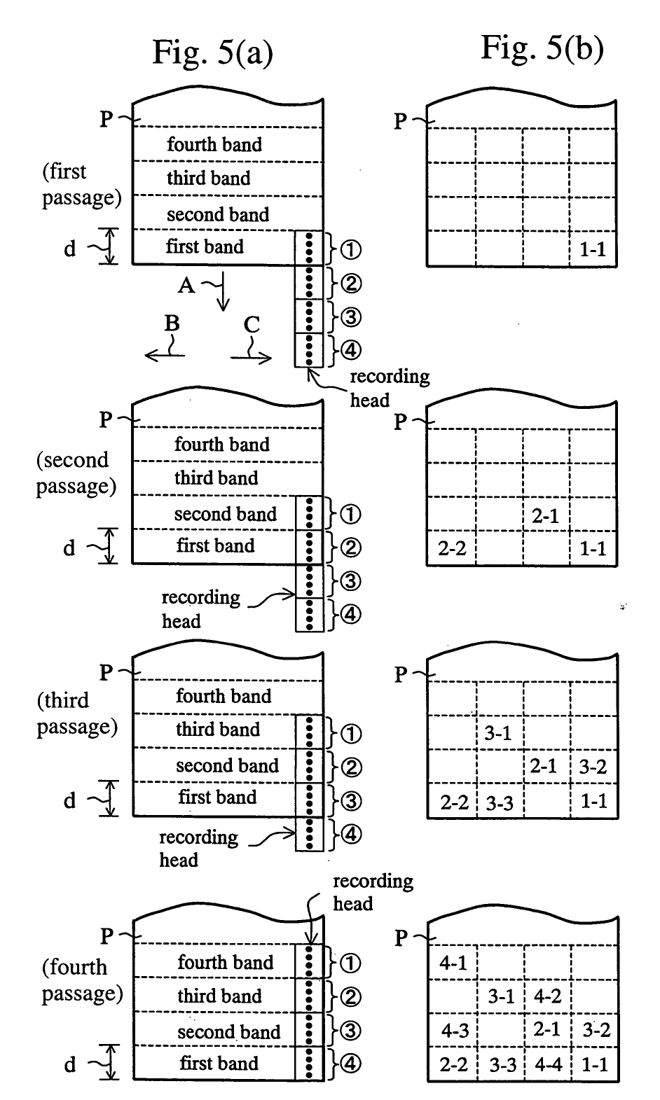

A conventional multi-passage printing is explained by reference to FIG. 3 and FIG. 4. Here the recording head 22K is explained. The other recording heads 22C, 22M, and 22Y are similar to the recording head 22K.

FIG. 3 shows a completed print. In FIG. 3, the symbol “a” indicates a printed dot. FIG. 4 is a drawing for explaining a printing process for printing the completed print in FIG. 3. Four-passage printing is explained here by reference to these drawings. In FIG. 4, the arrows B and C indicate the carriage scanning directions, the arrow mark A indicates the paper delivery direction, the symbol d indicates the distance of the paper sheet delivery in one step, and the circled numerals 1 to 4 indicate the ordinal numbers of the nozzles of the recording head 22K used for the printing. Normally, the paper sheet is delivered stepwise by the prescribed distance d, and an image is formed by operating the carriage once in every paper sheet delivery step. The dots in FIG. 3 are formed by using the nozzles in the order shown in FIG. 4.

This example shows a four-passage printing process. Generally the multi-passage printing process includes n-passage printing in which one band of an image is formed by n-steps of the sheet delivery, and multiple passage printing in which one band of an image is formed by printing with several times of carriage scanning without the sheet delivery.

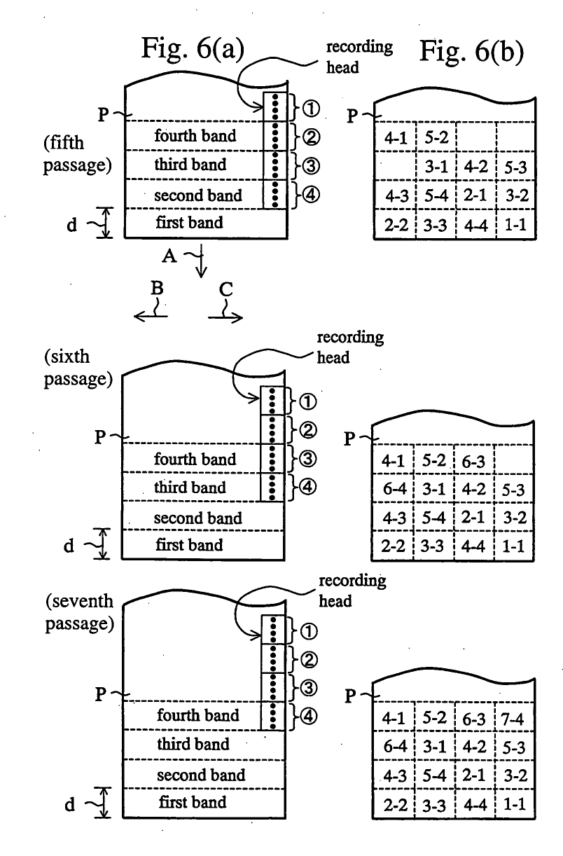

An example of the multi-passage printing process is described in detail by reference to FIG. 5 and FIG. 6.

In FIG. 5, the drawings in the series (a) (vertical series) explain schematically the positional relation between the recording medium and the recording head, and the drawings in the series (b) explain the regions of images formed on a recording medium by recording heads. The terms “first passage” to “fourth passage” indicate the order of formation of the images (by passage of (or scanning with) the recording head). FIG. 6 is continuation of FIG. 5. The drawings in the series (a) explain schematically the positional relation between the recording medium and the recording head, and the drawings in the series (b) explain the regions of images formed on a recording medium by respective recording heads. The terms “fifth passage” to “seventh passage” indicate the order of formation of the image after the fourth passage in FIG. 5.

A process is explained for formation of images in the regions indicated by the diagrams (b) in FIG. 6 in the seventh passage by symbols 1-1, 2-1, . . . , 6-4, and 7-4. The image formed in the regions indicated by the symbols 1-1, 2-1, . . . , 6-4, and 7-4 includes various shapes of images such as straight lines, planes (e.g., a black solid), and curves. For example, the symbol 6-4 indicates a region of an image formed in the sixth passage by the nozzle group indicated by the circled numeral 4 (nozzle group 4). This region is named hereinafter region 6-4. That is, the symbol “m-n” indicates the image region formed in the m-th passage by a nozzle group n. In FIG. 5 and FIG. 6, the nozzle (precisely, the outlet of the nozzle, or the ink ejection opening) is represented by a black solid circle schematically. Only 16 black solid circles are shown in FIGS. 5 and 6, but generally a recording head has more than 1000 nozzles. In this example, these nozzles are aligned in a line in the arrow-A direction (paper sheet delivery direction).

The paper sheet delivery distance in one step (one band breadth) is the distance “d” shown in the drawings of the series (a). In formation of the image, the recording medium P is delivered by the distance d in one step in the arrow-A direction, and stopped temporarily. On the stopped recording medium P, an ink is ejected through a selected nozzle or nozzles (nozzle designated by the controlling assembly) out of the nozzles of the groups 1-4 by one reciprocation of the recording head in the arrows-B and arrow-C directions. After one reciprocating movement of the recording head in the arrow-A and arrow-B directions, the recording medium sheet P is again delivered in the arrow-A direction by the distance d, and is stopped. On the stopped recording medium P, an ink is ejected through a selected nozzle or nozzles (nozzle designated by the controlling assembly) out of the nozzle of the groups 1-4 by one reciprocation of the recording head in the arrows-B and arrow-C directions. Such a process is repeated to form an entire image on the recording medium P.

The process from the first passage in FIG. 5 to the seventh passage in FIG. 6 is explained sequentially. The first passage is conducted at the start of the image formation on the recording medium P, and the seventh passage is the final passage for completing the image formation.

In the first passage, the recording medium P (herein the margin is neglected) is delivered in one step in the arrow-A direction by the distance of one band breadth (corresponding to the distance d), and is stopped. Thereby, as shown in the diagram (a) of the first passage in FIG. 5, the group-1 nozzles come to be placed above the first band. In this state, the nozzles of groups 2 to 4 are placed in the downstream side of the front edge of the recording medium sheet P in the delivery direction (arrow-A direction), outside the recording medium sheet P. With the recording medium sheet P stopped, the recording head is allowed to reciprocate once in the main scanning direction (arrow-B and arrow-C directions), and the ink is ejected only from the group-1 nozzles. As mentioned above, the nozzle group-1 has plural nozzles, and the ink is ejected selectively from the nozzles in accordance with the image data transmitted to the recording head. The above operation forms the image of the first passage. In this step of first passage for image formation, the nozzles of groups 2-4 are treated for nozzle masking not to eject the ink (treatment to stop ink ejection from the prescribed nozzles). As the result, an image is formed only in the region 1-1 in the first band as shown in the diagram (b) of the first passage in FIG. 5.

In the second passage, after the image formation in the region 1-1 of the first band, the recording medium P is delivered one step in the arrow-A direction by the distance of one band breadth (corresponding to the distance d), and is stopped. Thereby, as shown in the diagram (a) of the second passage in FIG. 5, the group-2 nozzles come to be placed above the first band, and the group-1 nozzles come to be placed above the second band. In this state, the nozzles of groups 3 and 4 are placed outside the recording medium sheet P in the downstream side of the front edge of the recording medium sheet P in the delivery direction (arrow-A direction). With the recording medium sheet P stopped, the recording head is allowed to reciprocate once in the main scanning direction (arrow-B and arrow-C directions), and the inks are ejected from the group-1 nozzles and the group-2 nozzles. As mentioned above, the nozzle groups 1 and 2 have plural nozzles respectively, and the inks are ejected selectively from the nozzles in accordance with the image data transmitted to the recording head. This selective ink ejection is conducted similarly in the nozzle groups 3 and 4. The above operation forms the image of the second passage. In this step, the nozzles of groups 3 and 4 are masked not to eject the ink (treatment to prevent ink ejection from the prescribed nozzles). As the result, an image is formed in the region 2-2 in the first band and the region 2-1 of the second band as shown in the diagram (b) of the second passage in FIG. 5. (The image in the region 1-1 has already been formed in the first passage.)

In the third passage, after completion of the second passage, the recording medium sheet P is delivered in one step in the arrow-A direction by the distance of one band breadth (corresponding to the distance d), and is stopped. Thereby, as shown in diagram (a) of the third passage in FIG. 5, the group-3 nozzles come to be placed above the first band, the group-2 nozzles come to be placed above the second band, and the group-1 nozzles come to be placed above the third band. In this state, the nozzles of group 4 are placed outside the recording medium sheet P in the downstream side of the front edge of the recording medium sheet P in the delivery direction (arrow-A direction). With the recording medium sheet P stopped, the recording head is allowed to reciprocate once in the main scanning direction (arrow-B and arrow-C directions), and the inks are ejected from the group-1 nozzles, group-2 nozzles and the group-3 nozzles. The above operation forms the image of the third passage. In this step, the nozzles of groups 4 are masked not to eject the ink. As the result, an image is formed in the region 3-3 in the first band, in the region 3-2 of the second band, and the region 3-1 of the third band as shown in the diagram (b) of the third passage in FIG. 5. (The image in the region 1-1 has already been formed in the first passage, and the images in the regions 2-1 and 2-2 have already been formed in the second passage.)

In the fourth passage, after completion of the third passage, the recording medium sheet P is delivered one step in the arrow-A direction by the distance of one band breadth (corresponding to the distance d), and is stopped. Thereby, as shown in the diagram (a) of the fourth passage in FIG. 5, the group-4 nozzles come to be placed above the first band, the group-3 nozzles come to be placed above the second band, the group-2 nozzles come to be placed above the third band, and the group-1 nozzles come to be placed above the fourth band. With the recording medium sheet P stopped, the recording head is allowed to reciprocate once in the main scanning direction (arrow-B and arrow-C directions), and the inks are ejected from the group-1 nozzles, group-2 nozzles, the group-3 nozzles, and group-4 nozzles. The above operation forms the image of the fourth passage. As the result, an image is formed in the region 4-4 in the first band, in the region 4-3 of the second band, in the region 4-2 in the third band, and in the region 4-1 of the fourth band as shown in the diagram (b) of the fourth passage in FIG. 5. (The image in the region 1-1 has already been formed in the first passage, the images in the regions 2-1 and 2-2 have already been formed in the second passage, and the images in the regions 3-3 and 2-3 have already been formed in the third passage.)

In the fifth passage, after completion of the fourth passage, the recording medium sheet P is delivered one step in the arrow-A direction by the distance of one band breadth (corresponding to the distance d), and is stopped. Thereby, as shown in the diagram (a) of the fifth passage in FIG. 6, no nozzle group is placed above the first band, the group-4 nozzles come to be placed above the second band, the group-3 nozzles come to be placed above the third band, the group-2 nozzles come to be placed above the fourth band, and the group-1 nozzles come to be placed outside the regions of the image formation (the regions corresponding to the first to fourth bands). With the recording medium sheet P stopped temporarily, the recording head is allowed to reciprocate once in the main scanning direction (arrow-B and arrow-C directions), and the inks are ejected from the group-2 nozzles, the group-3 nozzles, and the group-4 nozzles. The above operation forms the image of the fifth passage. As the result, as shown in the diagram (b) of the fifth passage in FIG. 6, an image is formed in the region 5-4 in the second band, in the region 5-3 in the third band, and in the region 5-2 in the fourth band. (The image in the region 1-1 has already been formed in the first passage, the images in the regions 2-1 and 2-2 have already been formed in the second passage, the images in the regions 3-1 and 3-2 have already been formed in the third passage, and the images in the regions 4-1, 4-2, 4-3, and 4-4 have been formed in the fourth passage.)

In the sixth passage, after completion of the fifth passage, the recording medium sheet P is delivered one step in the arrow-A direction by the distance of one band breadth (corresponding to the distance d), and is stopped. Thereby, as shown in the diagram (a) of sixth passage in FIG. 6, no nozzle group is placed above the first band and the second band, the group-4 nozzles come to be placed above the third band, the group-3 nozzles come to be placed above the fourth band, and the group-1 nozzles and the group-2 nozzles, which are placed in the upstream side of the fourth band in the delivery direction (arrow-A direction), come to be placed outside the regions of the image formation (the regions corresponding to the first to fourth bands). With the recording medium sheet P stopped temporarily, the recording head is allowed to reciprocate once in the main scanning direction (arrow-B and arrow-C directions), and the inks are ejected from the group-3 nozzles, and the group-4 nozzles. The above operation forms the images of the sixth passage. As the result, as shown in the diagram (b) of the sixth passage in FIG. 6, images are formed in the region 6-4 in the third band, and in the region 6-3 in the third band. (The image in the region 1-1 has already been formed in the first passage, the images in the regions 2-1 and 2-2 have already been formed in the second passage, the images in the regions 3-2 and 3-3 have already been formed in the third passage, the images in the regions 4-1, 4-2, 4-3, and 4-4 have been formed in the fourth passage, and the images in the regions 5-2, 5-3, and 5-4 have already been formed in the fifth passage.)

In the seventh passage, after completion of the sixth passage, the recording medium sheet P is delivered one step in the arrow-A direction by the distance of one band breadth (corresponding to the distance d), and is stopped. Thereby, as shown in the diagram (a) of the seventh passage in FIG. 6, no nozzle group is placed above the first band, the second band, and the third band, the group-4 nozzles come to be placed only above the fourth band, and the group-1 nozzles, the group-2 nozzles, and the group-3 nozzles, which are placed in the upstream side of the fourth band in the delivery direction (arrow-A direction), come to be placed outside the regions of the image formation (the regions corresponding to the first to fourth bands). With the recording medium sheet P stopped temporarily, the recording head is allowed to reciprocate once in the main scanning direction (arrow-B and arrow-C directions), and the inks are ejected from the group-4 nozzles only. The above operation forms the image of the seventh passage. As the result, as shown in the diagram (b) of the seventh passage in FIG. 6, an image is formed in the region 7-4 in the fourth band. (The images in the other regions have already been formed in the first to sixth passages).

In the multi-passage printing as described above, the entire image is not formed at a time in the full breadth of the nozzle alignment (the length of the alignment of the 16 nozzles of the groups 1-4 from the upstream end to the downstream end in the arrow-A direction). The region of the entire nozzle breadth of the recording medium sheet is divided into plural bands arranged successively in the recording-medium sheet delivery direction (arrow-A direction); each of the band is further divided evenly into regions (e.g., region 1-1 to region 7-4, above) (perpendicular to the arrow-A direction); and the (regional) images are formed by ejecting an ink onto each of the regions in each of the bands by changing the timing of the ink election of the respective nozzle groups (by different passages). The image formed on one band is constituted of partial images formed by plural passages. Therefore, slight variation of the distance of delivery of the recording medium sheet will not cause a linear black or white streak in the main scanning direction (arrow A and B directions), which makes less remarkable the black or white streaks.

However, lately the resolution of the plotter 10 is becoming finer, so that the black or white streaks which are not remarkable can become remarkable. For preventing such a black or white streak, the deviation of the paper sheet delivery should be minimized. A method of adjusting the delivery of the recording medium sheet for minimizing the deviation (error) of the distance of delivery of the recording medium sheet is explained below.

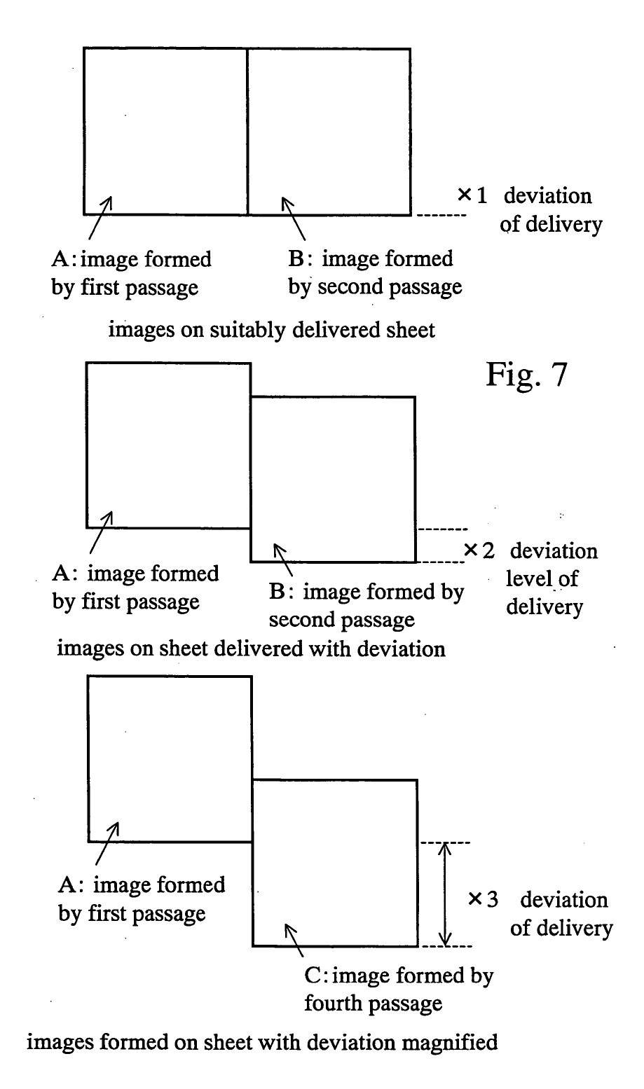

The method for adjusting the paper sheet delivery is explained as a comparative example of the present invention by reference to FIG. 7 and FIG. 8.

FIG. 7 is a schematic drawing for explaining deviation of the stepwise delivery distance of the paper sheet. The upper drawing in FIG. 7 shows a state of precise sheet delivery, and the middle drawing shows a state of deviation of the sheet delivery. In FIG. 7, the symbol A denotes an image formed in the first passage, the symbol B denotes an image formed in the second passage, X1 and X2 denote deviation of the paper sheet delivery. In FIG. 8, the drawings on the left side illustrate schematically confirmation printing at the adjustment level of 0 (zero), and the drawings on the right side illustrate schematically confirmation printing in which the adjustment level of +1 is optimum. In FIG. 8, the dotted line shows timing for changing the adjustment level, the symbol A corresponding first passage printing, and the symbol B corresponding to fourth passage printing.

Usually, when the paper sheet delivery is not correct, a black or white streak emerges between the formed image bands to give a defective image. However, the resolution of the output of the current inkjet type image-forming apparatus is extremely fine, so that it is very difficult to judge the optimum adjustment by comparing the deviation in the first passage and the deviation in the second passage. Further, in a usual n-passage printing, it is much more difficult to confirm the state of the paper sheet delivery by examining the superposed n-passage print.

To solve this difficulty, as shown by the bottom drawing in FIG. 7, the deviation of the paper sheet delivery can be magnified by comparing the image A formed by the first passage A and the image C formed by the fourth passage deviating by X3. In this case, the deviation X3 of the bottom drawing is three times larger than the deviation X2 of the middle drawing. Further, as shown in FIG. 8, the optimum correction factor can readily be found by printing several times by changing the adjustment level. In such a manner, the optimum adjustment level can be found by printing successively the same confirmation pattern by changing the adjustment level (correction factor). However, such a simple adjustment is possible insofar as the delivery roller 24 (FIG. 1) is not eccentric, as mentioned later.

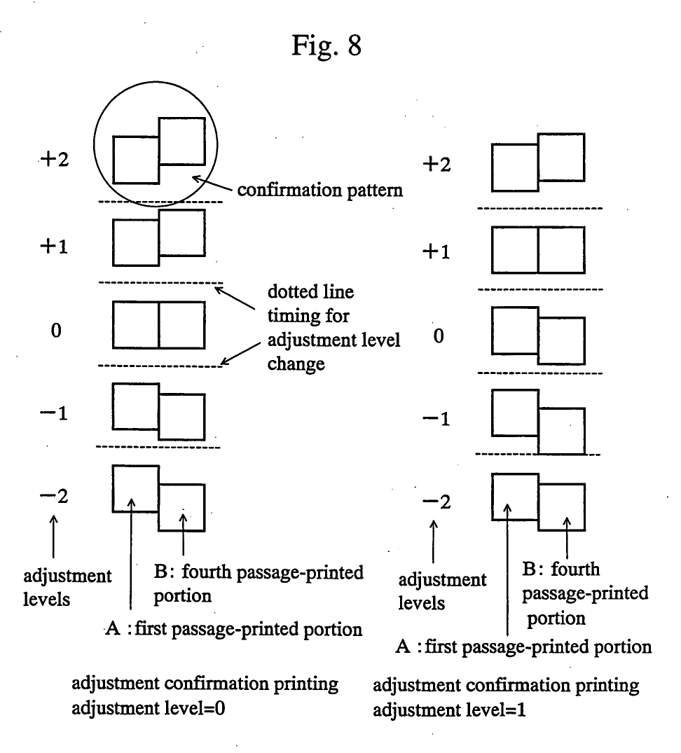

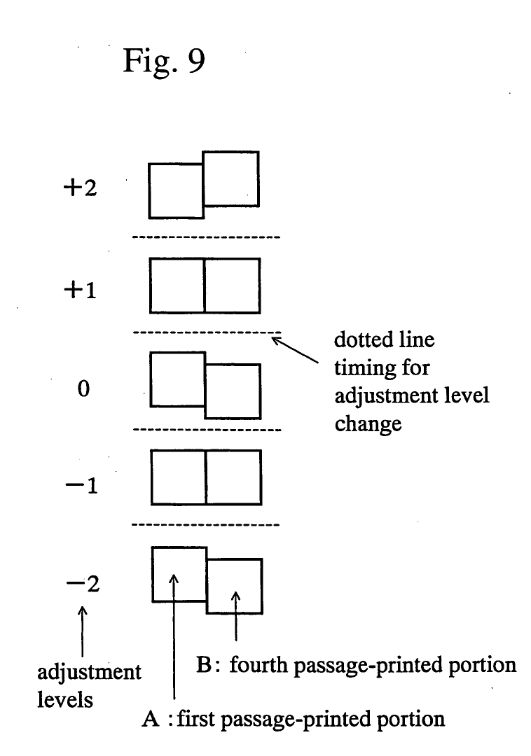

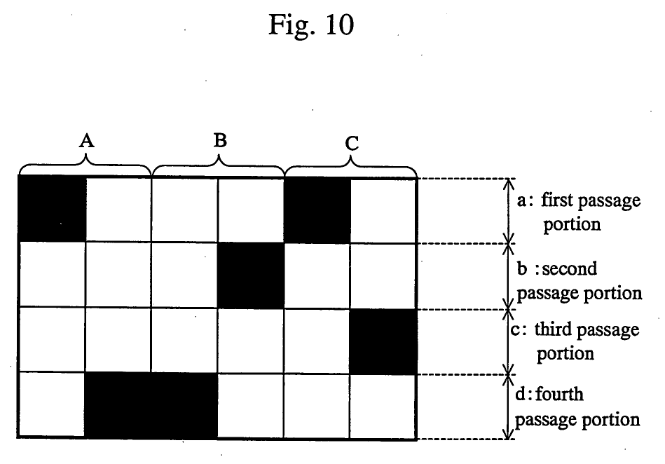

The deviation of the paper sheet delivery distance and adjustment of the paper sheet delivery are explained for the case where the delivery roller is eccentric, by reference to FIG. 9 and FIG. 10. This method of adjustment of the paper delivery distance is one example of the present invention.

FIG. 9 illustrates schematically deviation of the paper sheet delivery when a delivery roller has an eccentric rotation axis. FIG. 10 is a drawing for explaining the adjustment of the paper sheet delivery distance in the case where the delivery roller is eccentric.

When the delivery roller 24 (FIG. 1) is eccentric, the suitable correction level may be observed at two levels, +1 and −1, in the correction confirmation printing, which makes impossible judgment of the precise correction level. This is because the delivery distance per unit rotation angle varies with the rotation angle of the eccentric roller although the optimum correction level should naturally be found at one point.

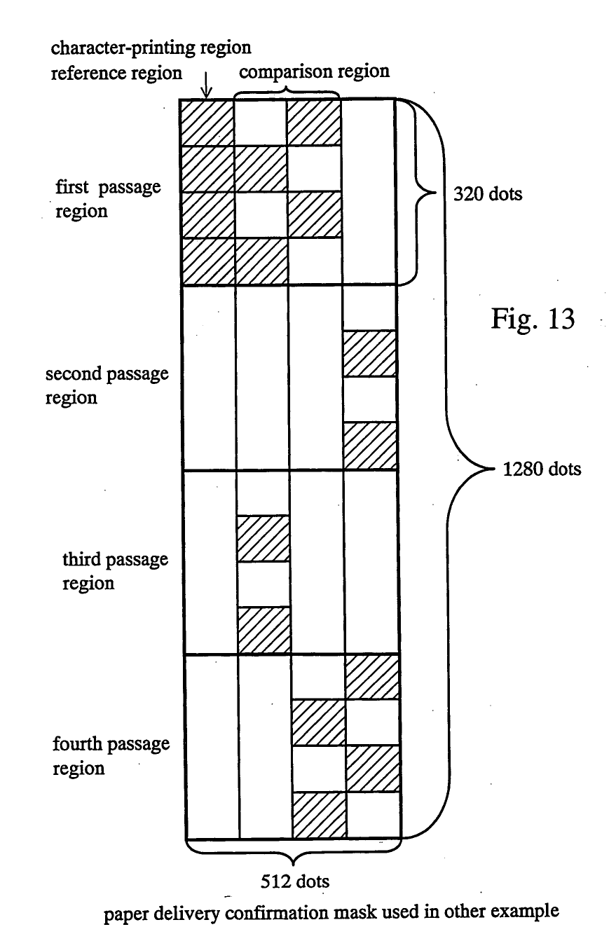

As mentioned above, with an eccentric delivery roller, the suitable correction level may be observed at two points of +1 and −1, but the suitable level may be at zero. This is because the sheet delivery confirmation mask does not fit to the diameter of the delivery roller, so that the print comes to deviate owing to the eccentricity of the delivery roller. In the present invention, the deviation of the paper sheet delivery distance can be detected surely even with an eccentric roller by use of a delivery confirmation mask shown in FIG. 13 described later.

To meet the deviation of the paper sheet delivery as shown in FIG. 9, one band of a multi-passage printing (three or more passage printing) is divided into plural sub-regions and the printing is conducted on the sub-regions independently by different passages. In FIG. 10, the portion A is utilized for detection of the deviation of the paper sheet delivery distance by comparison of the first passage print and the fourth passage print; the portion B, by comparison of the second passage print and fourth passage print; and at the portion C, by comparison of the first passage print and the third passage print. Thereby, in actual printing, the deviation of the print start position deviates to decrease the adverse effect of the eccentricity of the delivery roller. Thus, the optimum adjustment level of the paper sheet delivery can be decided by the uniform image formed throughout the entire regions.

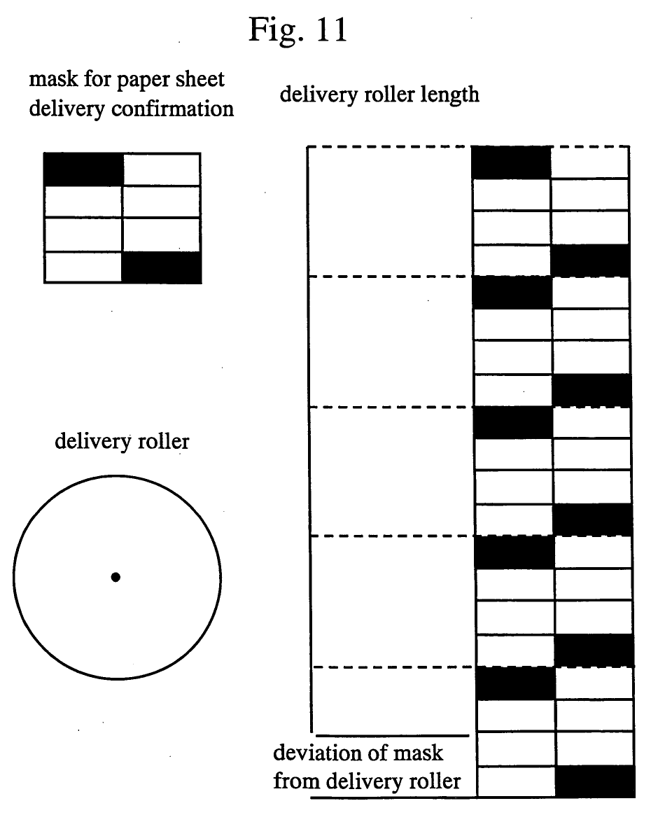

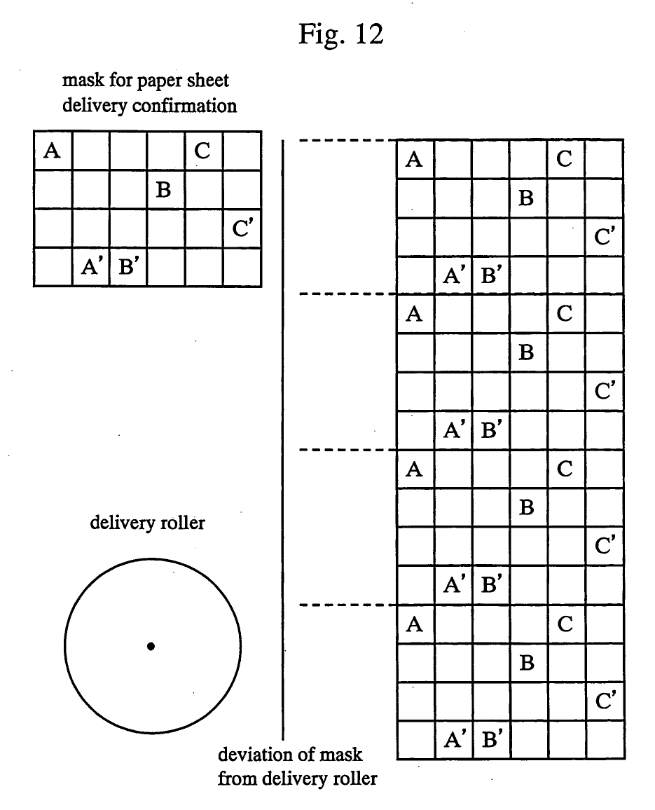

The relation between the sheet delivery confirmation mask and the delivery roller is explained below by reference to FIG. 11 and FIG. 12.

FIG. 11 shows the relation between the sheet delivery confirmation mask and the delivery roller in a comparative example. FIG. 12 shows the relation between the sheet delivery confirmation mask and the delivery roller in the present invention.

In the comparative example, as shown in FIG. 11, the length of the printing mask is different from the perimeter of the delivery roller. Therefore, the starting position of the printing mask in the second rotation of the roller is different from that in the first rotation. This will not cause a problem insofar as the roller axis is precisely at the center. However, actually, the delivery roller is somewhat eccentric. This can cause a difference between the first printing position and the second printing position, and plural adjustment levels can be detected in the paper sheet delivery adjustment printing.

On the other hand, with the sheet delivery confirmation mask of the present invention, as shown in FIG. 12, the suitable delivery adjustment level can be detected at three positions: A-A′, B-B′, and C-C′. The positions A-A′ are provided in a conventional manner, but at positions B-B′, and C-C′, the phases are shifted. In conventional patterns, at A-A′ portions, the starting position deviates at the second rotation, whereas (in the present invention), at the portions of B-B′ and C-C′, the printing is conducted in the order of B-B′ and C-C′ in the first rotation and in the order of C-C′ and B-B′ in the second rotation. Thereby the portions of BB′ and CC′ can be printed at constant intervals independently of the rotation of the delivery roller.

As the result, even when the suitable adjustment levels are found in plurality by examination of A-A′ only, the optimum adjustment level can be detected definitely even with an eccentric delivery roller by providing the mask portions at phase-shifted positions like B-B′ and C-C′.

Even when the intervals of the sheet delivery confirmation printing mask is not suitable for the delivery roller, the optimum level can be decided definitely in any case owing to the mask having the phase shift in several positions. In FIG. 12, four-passage printing is taken as an example, but this system is applicable practically in multi-passage printing of three or more passages.

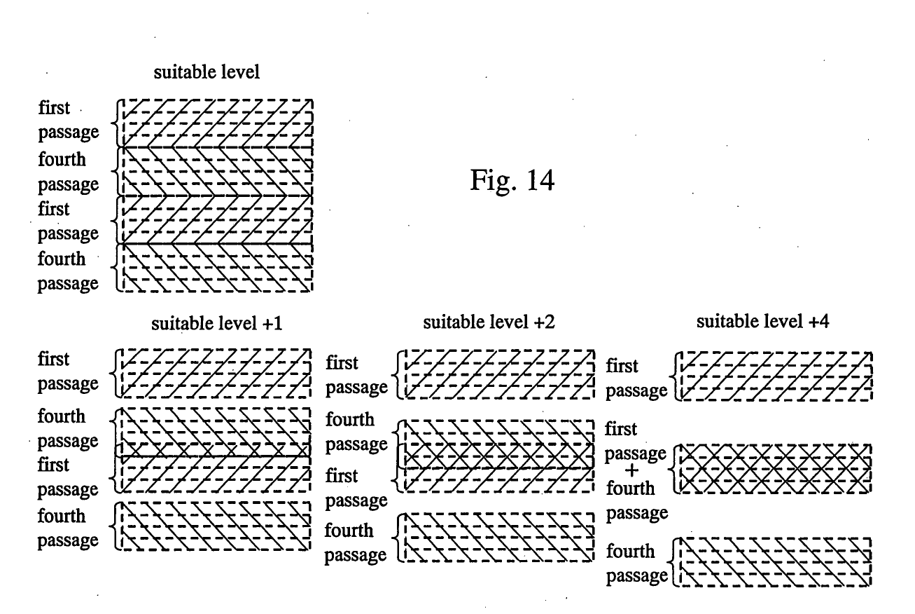

Another example of use of the paper sheet delivery confirmation mask is explained briefly by reference to FIG. 13 and FIG. 14. In this example, the main body has the same constitution as that of the preceding embodiment, and the adjustment levels are printed with enlargement in the same manner as above.

FIG. 13 is a drawing for explaining the sheet delivery confirmation printing mask employed in this example. FIG. 14 is a magnified drawing for explaining deviation of the paper sheet delivery distance.

With the sheet delivery confirmation printing mask in FIG. 13, the deviation of the paper sheet delivery is shown by a plane, which is different from the above example in which the deviation is detected by the lateral side positional deviation. Further this mask has character-printing regions, reference regions, and comparison regions. Usually, the delivery is confirmed by the images in the comparison region and the reference region, and the character-printing region can be used for outputting a numeral indication of the adjustment level. In confirmation of the adjustment level with this mask, the image in the reference region is formed by one passage in a uniform pattern. On the other hand in the comparison region, an image in a first passage and an image in a fourth passage are combined to form a uniform pattern. Therefore deviation of the adjustment level can be readily detected by non-uniformity of the pattern. FIG. 14 shows schematically the deviation in the pattern of the comparison region under magnification.

By the above confirmation printing, the absence of the deviation can be readily and visually confirmed. Otherwise, optical density detection sensor may be attached to the carriage, and the optimum adjustment level can be decided by scanning the print region with the carriage for comparison of the density. Further in the adjustment method of the present invention, the adjustment may be conducted by supplementing the images at the first print and the final print: the printing time can be shortened by conducting only the paper sheet delivery without carriage scanning.

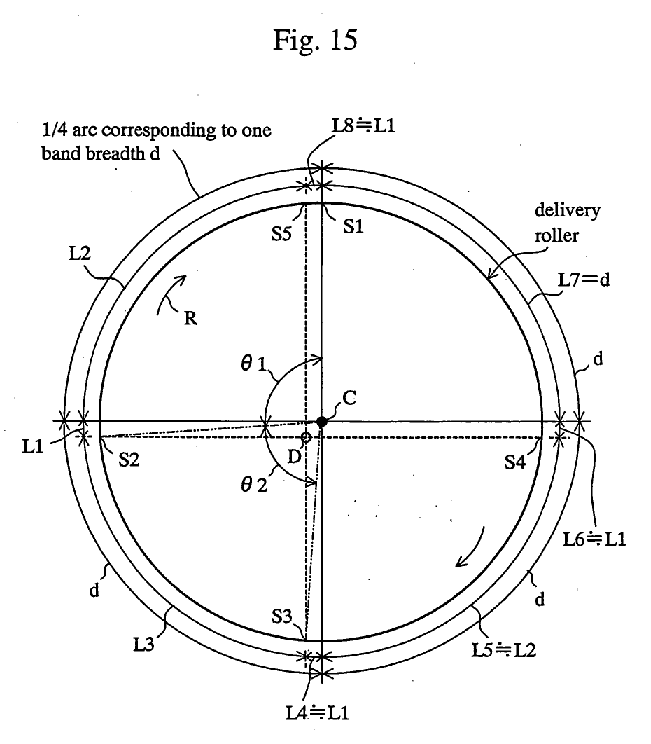

Next, the sheet delivery by an eccentric delivery roller is explained below in detail by reference to FIGS. 15-20.

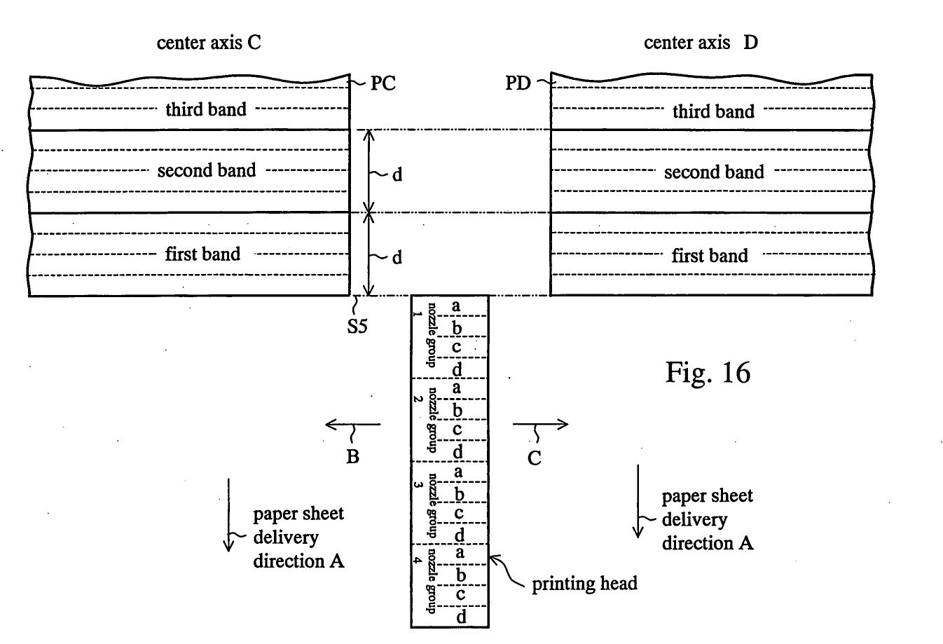

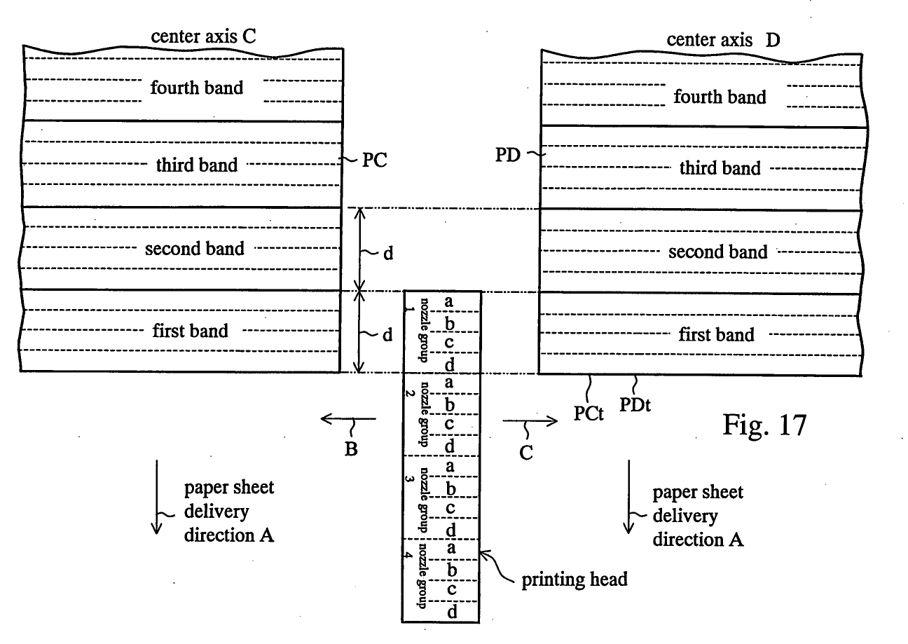

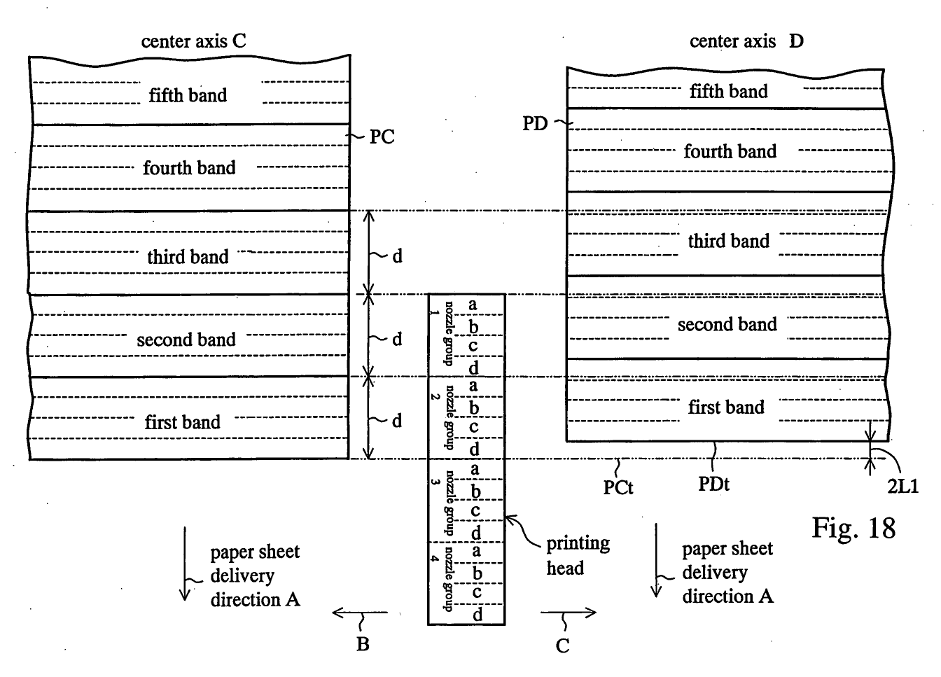

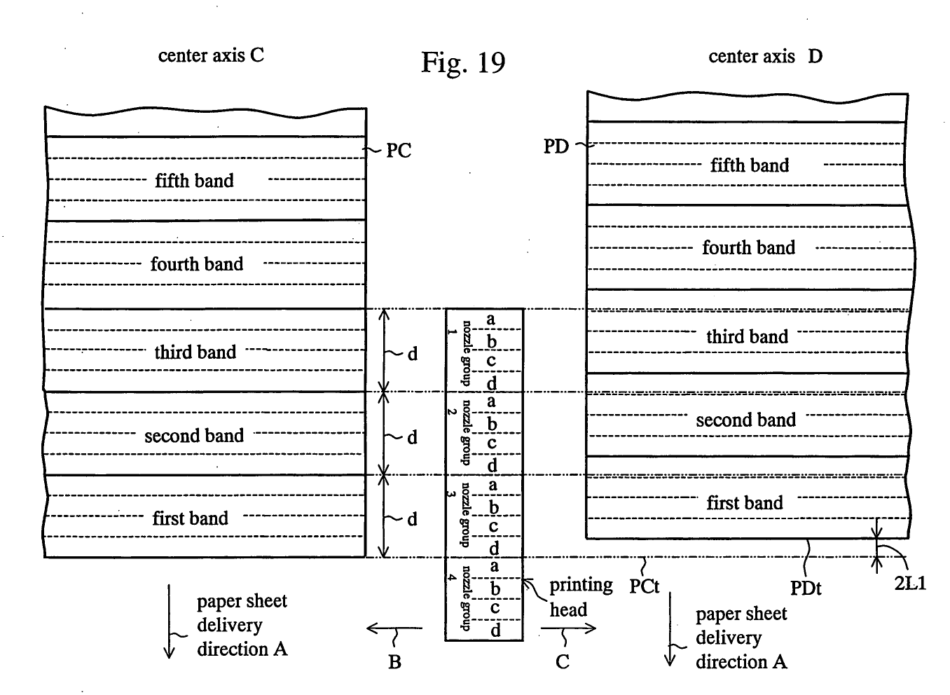

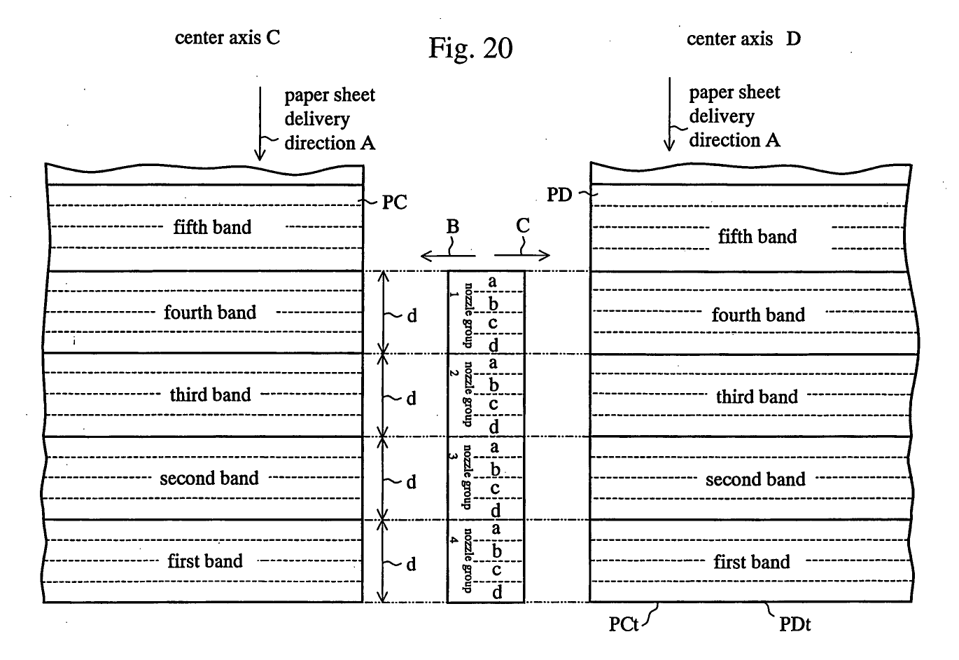

FIG. 15 illustrates schematically a rotation state of a delivery roller. FIG. 16 is a plan view illustrating schematically a positional relation of a recording medium and a recording head immediately before start of rotation of a delivery roller: The recording medium PC is delivered by a roller having a center axis C for the rotation; the recording medium PD is delivered by a roller having a de-centered rotation axis D. FIG. 17 is a plan view illustrating schematically a positional relation of the recording mediums PC and PD and the recording head at the instant when the delivery roller has been turned rotated by a first ¼ rotation. FIG. 18 is a plan view illustrating schematically a positional relation of the recording mediums PC and PD and the recording head at the instant when the delivery roller has been turned by a second ¼ rotation. FIG. 19 is a plan view illustrating schematically a positional relation of the recording mediums PC and PD and the recording head at the instant when the delivery roller has been turned by a third ¼ rotation. FIG. 20 is a plan view illustrating schematically a positional relation of the recording mediums PC and PD and the recording head at the instant when the delivery roller has been turned by a fourth ¼ rotation.

In FIGS. 16-20, the recording medium PC and the recording medium PD are shown side by side for comparison. Actually, however, they are not delivered side by side. The recording head shown in FIGS. 16-20 has plural nozzles aligned in the paper delivery direction. In this example, the nozzles are divided into four groups (group 1 to group 4). The nozzle groups include respectively the same number of nozzles. Further, the nozzles in the nozzle groups 1-4 are divided respectively into four sub-groups (sub-groups a, b, c, and d). The nozzle sub-groups include respectively the same number of nozzles. The breadth of the respective nozzle sub-groups a-d is equal to each other (length in the paper sheet delivery). The length of the respective nozzle groups 1-4 is equal to the breadth “d” of the one band. The length of the respective nozzle sub-groups a-d in the paper sheet delivery direction is equal to ¼ of the one band breadth d (i.e., d/4). The print on the recording medium PC and PD is formed in plural bands having a breadth “d” extending in the main scanning direction of the nozzles (arrow-B direction and arrow-C direction), the bands being named a first band, a second band, a third band, and so forth in the order from the downstream side of the main scanning direction. In the drawings, the boundaries between the bands are shown by continuous lines, the lines being not actually formed on the recording medium PC or PD. Each band is equally divided into smaller bands. The boundaries of the smaller bands are shown by broken lines, the broken lines being not actually formed on the recording medium PC or PD. In the drawings, the two-dot chain lines extending in the main scanning direction are drawn to show the deviation of the delivery distance of the recording medium PD from that of the recording medium PC, the two-dot chain lines being not actually formed on the recording medium PC or PD. The positional relation between the recording head and the recording medium PC and PD is different from the actual positional relation.

Here, the delivery roller 24 (FIG. 2) is presumed to be designed to deliver, by ¼ rotation, the recording medium by one band breadth distance (corresponding to the distance d) in the paper sheet delivery direction (arrow-A direction). That is, the delivery roller delivers, by one rotation, the recording medium by the distance of four band breadth (d×4).

The center axis C of the rotation of the delivery roller is connected to a stepping motor (delivery motor 120 in FIG. 2). The center axis C is turned by a center angle 90° by a stepping motor, whereby the recording medium is delivered by a distance of one band breadth d. This delivery by the distance d can be achieved only when the delivery roller is constituted to rotate precisely on the designed center axis C. However, the center axis of the delivery roller may be dislocated owing to the tolerable errors of parts constituting the inkjet type image-forming apparatus. Thus the roller may actually be rotated, for example, on the dislocated center axis D. That is, the center axis C may be dislocated to the position of the center axis D, whereby the delivery roller is actually be rotated on the displaced center axis D. Here, the delivery roller is assumed to be rotated on such a dislocated center axis D. Further, in the design, the rotation of the delivery roller is started from the position S1 (rotation starting position, actually a straight line perpendicular to the paper face of FIG. 15). That is, as shown in FIG. 16, the front edge of the recording medium is placed at the position S1, and the image formation is started by rotating the delivery roller by ¼ rotation (the margin of the recording medium being is neglected here).

Although the delivery roller is designed to rotate on the center axis C, actually the delivery roller is rotated on the center axis D owing to the dislocation of the center axis. The delivery roller is turned stepwise by a central angle 90° by the stepping motor (not shown in the drawing) on the center axis D. By the first ¼ rotation, the delivery roller delivers the recording medium PD by a distance corresponding to the length of the arc from the point S5 to the point S2 on the periphery. This rotation of the delivery roller from S5 to S2 delivers the recording medium PD by a distance of L2+L1 (distance d corresponding to the band breadth). Thereby as shown in FIG. 17, the recording medium PD is delivered by the one band breadth d, the front edge PDt or the recording medium PD being delivered by the same distance as the designed delivery distance of the front edge PCt of the recording medium PC.

By the next (second) ¼ rotation, the delivery roller delivers the recording medium PD by the distance corresponding to the length of the arc from the point S2 to the point S3 on the periphery, the delivery distance of the recording medium PD being L3=d−L1−L4 (one band breadth d minus 2×L1). That is, the delivery distance of the recording medium PD is shorter than the one band breadth by about 2×L1 (twice the distance L1). Thus after the second ¼ rotation, the front edge PDt of the recording medium PD is placed behind the front edge PCt of the recording medium PC delivered as designed by the distance 2L1 in the recording medium delivery direction (at the upstream side in the arrow-A direction). In a case where the distance d is 20 mm and the length L1 is 2 mm, the second ¼ rotation of the delivery roller delivers the recording medium PD by 16 mm (delivery distance: 16 mm).

After the above second ¼ rotation, subsequently the delivery roller is driven for a third ¼ rotation to deliver the recording medium by the distance corresponding to the length of the arc from the point S3 to the point S4 on the perimeter of the delivery roller. Thereby the recording medium is delivered by the distance of L4+L5=L1+L2 (the distance being equal to the one band breadth d). That is, the recording medium is delivered by the distance d nearly equal to the one band breadth d. As the result, after the third ¼ rotation, the front edge PDt of the recording medium PD comes to be placed behind the position of the front edge PCt of the recording medium PC delivered as designed by a distance 2L1 in the recording medium sheet delivery direction. In a case as above where the distance d is 20 mm and the length L1 is 2 mm, the third ¼ rotation of the delivery roller delivers the recording medium PD by 20.0 mm (delivery distance: 20.0 mm).

By the fourth ¼ rotation after the rotation for the delivery of distance d equal to the one band breadth, the delivery roller delivers the recording medium by a distance corresponding to the length of the arc from the point S4 to the point S5 on the perimeter of the delivery roller. This rotation from S4 to S5 delivers the recording medium by a distance L6+L7+L8=d+2×L1 (distance of the one band breadth d+2×L1). That is, the recording medium is delivered by a distance longer than the one band breadth d by about 2×L1. As the result, after the fourth ¼ rotation (totally one rotation, or one round), the front edge PDt of the recording medium PD comes to be placed at the same position as the front edge PCt of the recording medium PC delivered as designed. In a case as above where the distance d is 20 mm and the length L1 is 2 mm, the fourth ¼ rotation of the delivery roller delivers the recording medium PD by 24.0 mm (delivery distance: 24.0 mm).

As shown above, in the case where the delivery roller is driven stepwise by ¼ rotation on the de-centered rotation axis D, the recording medium PD is delivered in every ¼ rotation by a distance different from the designed delivery distance. However, after one rotation of the delivery roller, the delivery distance becomes equal to the designed distance. In the above example, the subsequent one rotation (second round) is started at the rotation starting position S5 which is the same position as the first round rotation.

On the other hand, the cross-section of the delivery roller can be not precisely circular, but can be ellipsoidal, having the diameter varying at the diameter measurement position. With such a delivery roller, the rotation starting position deviates in every one rotation, causing deviation of the image-forming region from the designed region as described later.

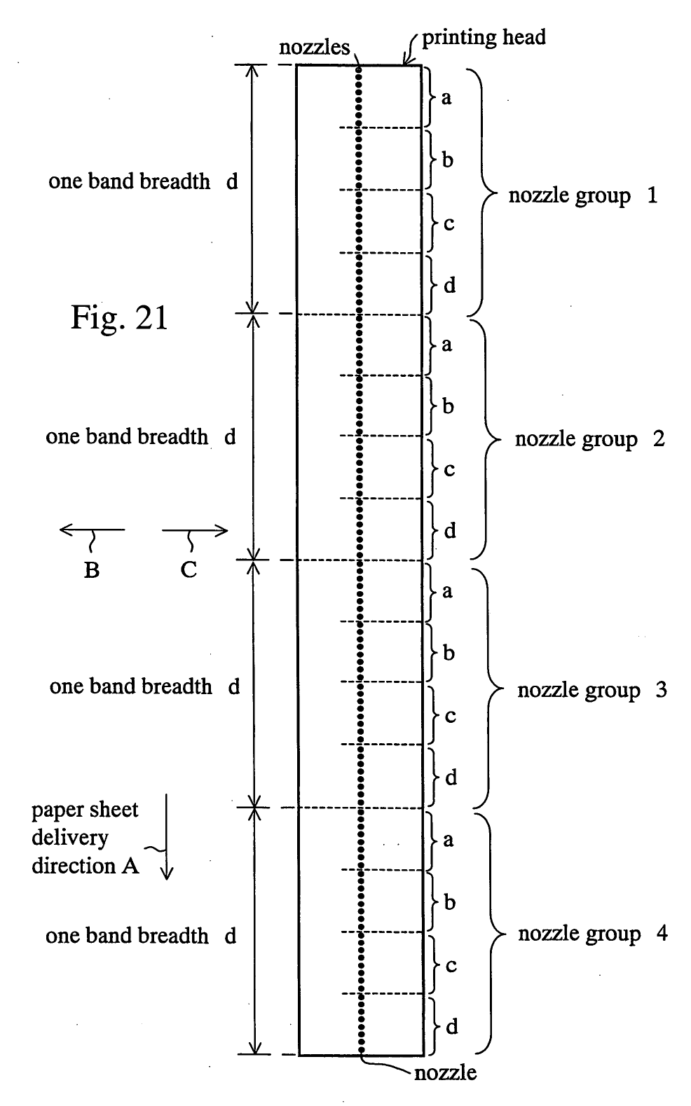

Firstly, the paper sheet delivery adjustment is explained in detail regarding the case where the sheet delivery distance after one rotation of the delivery roller is equal to the designed one and the subsequent (second) rotation is started at the same position S5 as the first rotation, by reference to FIG. 21 to FIG. 27.

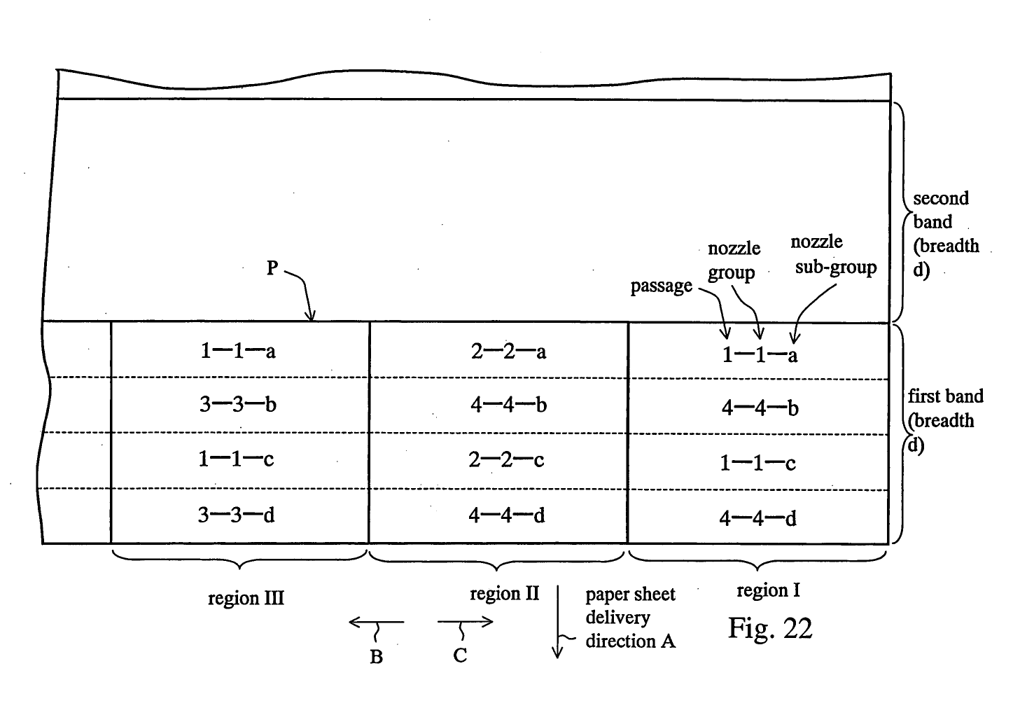

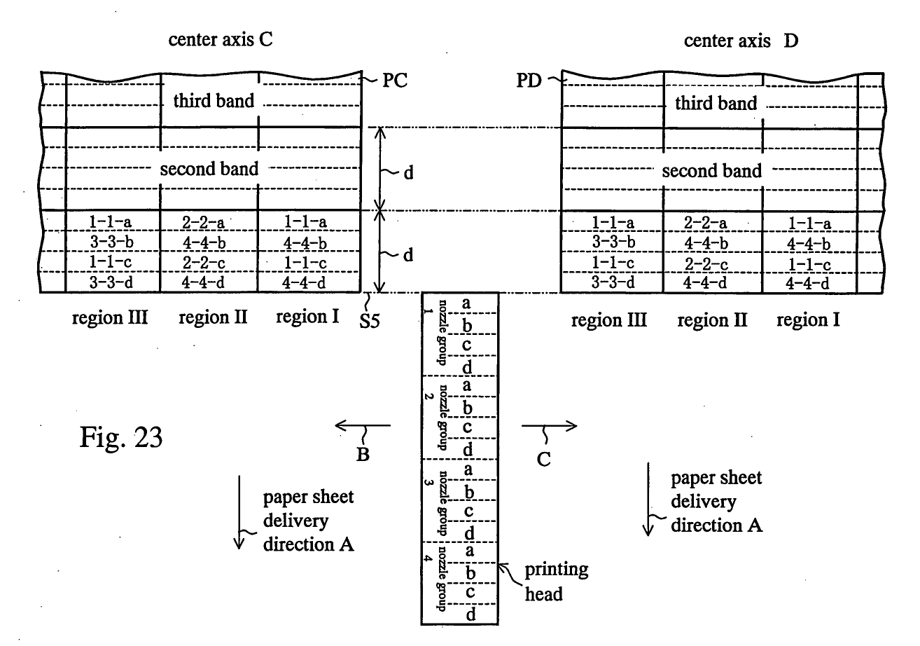

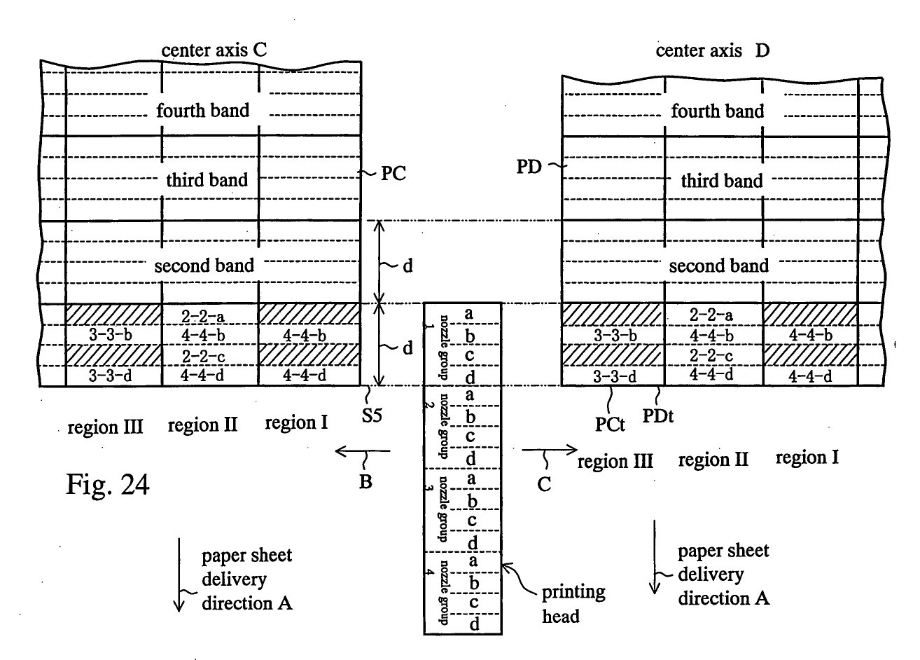

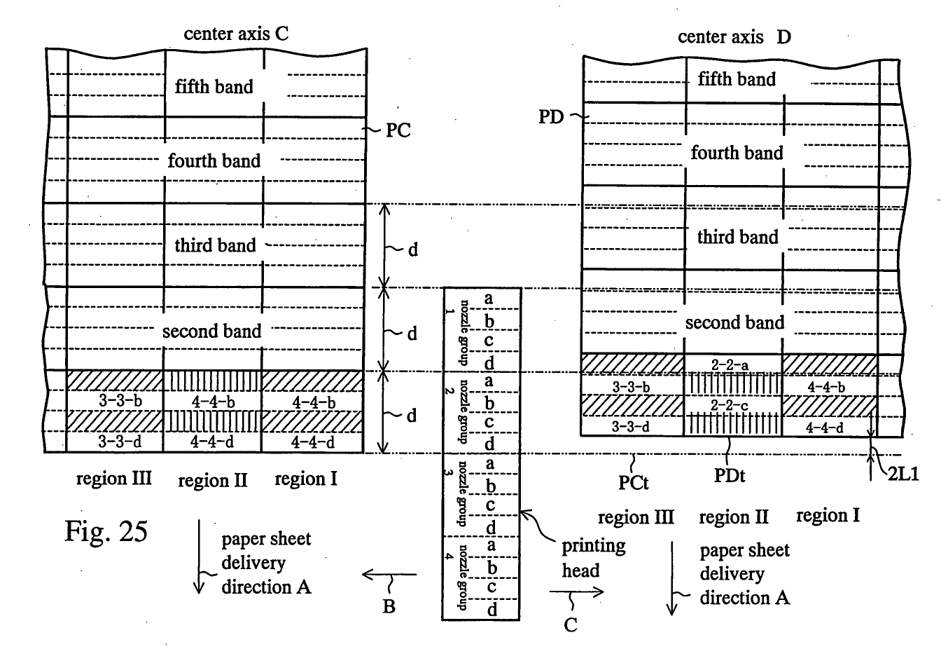

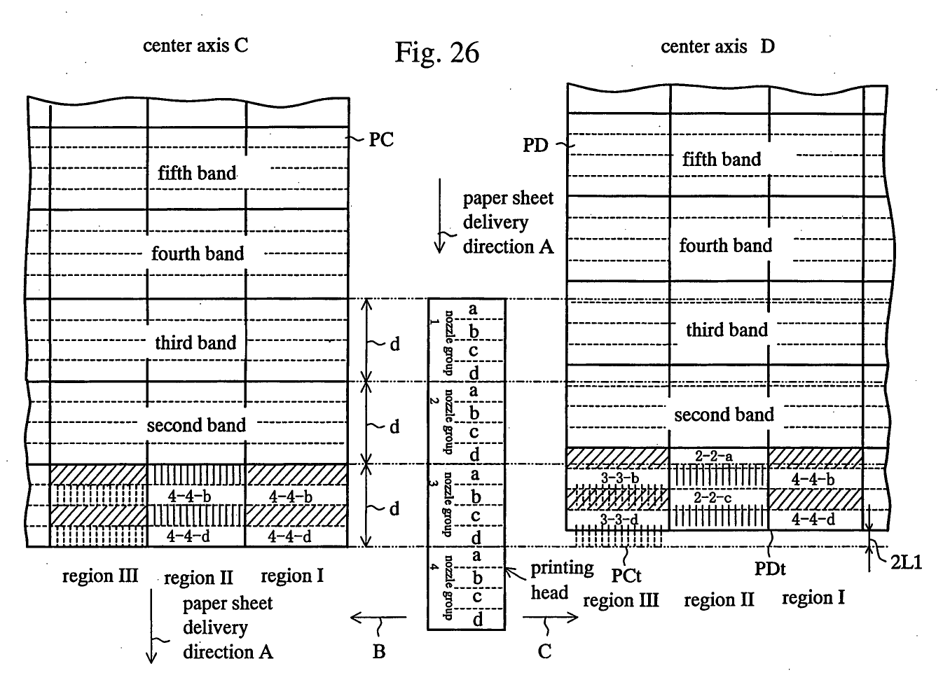

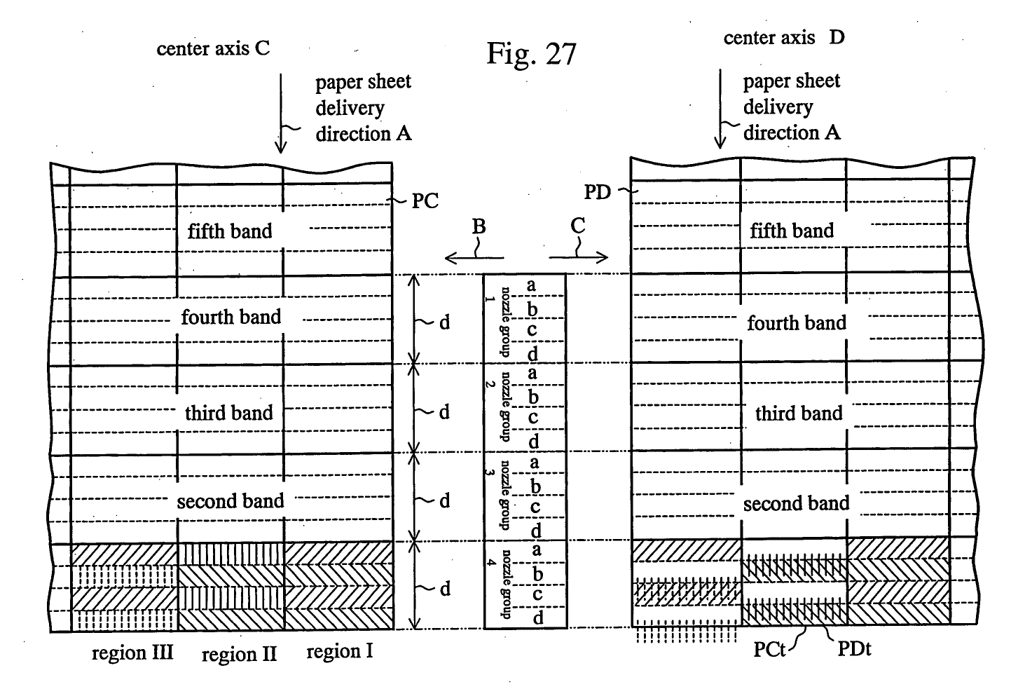

FIG. 21 illustrates schematically an example of nozzle groups of a recording head. FIG. 22 illustrates schematically sub-regions, smaller divisions of the one band region, for adjustment of the delivery distance. FIGS. 23 to 27 illustrate schematically process for forming images in the sub-regions as the indicator (reference) for adjusting the sheet delivery distance. Here, an example is explained in which the images for delivery distance adjustment are formed in the first band, but the images for the delivery distance adjustment may be formed in any band (any serial number of band) provided that the images for the adjustment are formed within the same band. In FIGS. 23-27, the same symbols are used as in FIGS. 16-20 for indicating the corresponding constituting elements. Further, in FIGS. 23-27, although two recording medium sheets, PC and PD, are shown side by side for explanation, the two sheets are not simultaneously delivered actually. FIG. 23 shows the recording head and the recording medium sheet at the positions corresponding to FIG. 16. FIG. 24 shows the positions of the recording head and the recording medium sheet corresponding to FIG. 17: The images formed as the indicator for delivery distance adjustment are shown by oblique lines or parallel lines. FIG. 25 shows the recording head and the recording medium sheets corresponding to FIG. 18: The images formed as the indicator for delivery distance adjustment are shown by oblique lines or parallel lines. FIG. 26 shows the recording head and the recording medium sheets corresponding to FIG. 19: The images formed as the indicator for delivery distance adjustment are shown by oblique lines or parallel lines. FIG. 27 shows the recording head and the recording medium sheets corresponding to FIG. 20: The images formed as the indicator for the delivery distance adjustment are shown by oblique lines or parallel lines.

The recording head has plural nozzles aligned in the paper sheet delivery direction as shown in FIG. 21. In FIG. 21, a small black solid circle denotes an outlet of a nozzle (ink ejection opening). Although for simplicity of the drawing, only 128 ink ejection openings are shown in FIG. 21, usually not less than 1000 nozzles are provided in a recording head. In this example, the nozzles are divided into four groups (nozzle groups 1, 2, 3, and 4), each nozzle group containing the same number of nozzles. Further each of the nozzle groups 1-4 are divided into four sub-groups (nozzle sub-groups a, b, c, and d), each nozzle sub-group containing the same number of nozzles. Each of the nozzle groups 1-4 has a length of one band breadth d in the paper sheet delivery direction. Further each of the nozzle sub-groups a-d has a length of ¼ of the band breadth (d/4).

For formation of a print pattern as an indicator for adjusting the sheet delivery distance, a part of one band (the first band in this example) is equally divided in the main scanning direction (arrow-B and arrow-C direction) into three regions: region I, region II, and region III (each of the region having a breadth (length in the paper sheet delivery direction) of d. And further each of the regions I, II, and III are divided into four portions having a width of d/4 in the paper sheet delivery direction. The above division forms 12 sub-regions. That is, the region I contains four sub-regions 1-1-a, 4-4-b, 1-1-c, and 4-4-d. The regions II and III contain respectively similarly sub-regions. Incidentally the symbol 1-1-a representing the sub-region of the region I signifies the sub-region in which the image is formed by ink ejection in the first passage (FIG. 5 and FIG. 6) from the nozzles of group-1, sub-group-a. Similarly, for example, in the sub-region 2-2-c of the region II, the image is formed by ejection of the ink in the second passage (FIGS. 5 and 6) from the nozzles of group-2, sub-group-c: in the sub-region 3-3-d of the region III, the image is formed by ejection of the ink in the third passage (FIGS. 5 and 6) from nozzles of group-3, sub-group-d.

The aforementioned sub-regions 1-1-a, 4-4-b, 1-1-c, and 4-4-d of the region I; the sub-regions 2-2-a, 4-4-b, 2-2-c, and 4-4-d of the region II; and sub-regions 1-1-a, 3-3-b, 1-1-c, and 3-3-d of the region III are examples of the first (combinations of) plural sub-regions in the present invention. Similarly the sub-region 1-1-a of the region I, the sub-region 2-2-a of the region II, and sub-region 1-1-a of the region III; the sub-region 4-4-b of the region I, the sub-region 4-4-b of the region II, and sub-region 3-3-b of the region III; the sub-region 1-1-c of the region I, the sub-region 2-2-c of the region II, and sub-region 1-1-c of the region III; the sub-region 4-4-d of the region I, the sub-region 4-4-d of the region II, and sub-region 3-3-d of the region III are examples of the second (combination of) plural sub-regions.

As shown in FIG. 15, the rotation of the delivery roller is started from the one point S5 (rotation starting position) on the perimeter of the roller (actually, a line perpendicular to the paper face of FIG. 15). Specifically, as shown in FIG. 23, the front edge of a recording medium sheet is placed at the position S5, and the delivery roller is turned by ¼ rotation to form an image (in the explanation, the margin of the recording medium is neglected).

The delivery roller is designed to rotate on the center axis C. As explained by reference to FIG. 17, the first ¼ rotation of the delivery roller delivers the recording medium sheet PD by the distance of the one band breadth d to bring the front edge PDt of the recording medium sheet PD in the same distance as the delivery of the front edge PCt of the recording medium sheet PC delivered as designed, as shown in FIG. 24. In this state, the recording medium sheet PD is stopped and the recording head is reciprocated once in the main scanning direction to form images in the sub-regions 1-1-a and 1-1-c of the region I, and the sub-regions 1-1-a and 1-1-c of the region III (printing in the first passage). In the sub-region 1-1-a, the image is formed by ejection of the ink from the sub-group-a nozzles of the group-1 nozzles: In the sub-region 1-1-c, the image is formed by ejection of the ink from the sub-group-c nozzles of the group-1 nozzles. In FIG. 24, these images are indicated by hatching with lines upward to the right. In this image formation, on the recording medium sheet PC delivered as designed, images are formed precisely within the sub-regions 1-1-a and 1-1-c in the regions I and III as shown in FIG. 24. On the other hand, on the recording medium sheet PD which has the front edge PDt at the same position as that of the front edge PCt of the recording medium sheet PC, images are formed precisely within the sub-regions 1-1-a and 1-1-c in the regions I and III as shown in FIG. 24.

The next (second) ¼ rotation of the delivery roller delivers the recording medium PD by a distance corresponding to the length of the arc from the point S2 to the point S3 on the perimeter. By this second delivery, as explained by reference to FIG. 18, the front edge PDt of the recording medium sheet PD comes to be placed behind (at the upstream side in the arrow-A direction of) the front edge PCt of the recording medium PC delivered as designed by a distance of 2L1 as shown in FIG. 25. On the recording medium sheet PD stopped in this state, the recording head is reciprocated once in the main scanning direction to form an image on the sub-region 2-2-a and the sub-region 2-2-c of the region II (second passage printing). The image on the sub-region 2-2-a is formed by ejection of ink through the sub-group-a nozzles of the nozzle group-2: The image on the sub-region 2-2-c is formed by ejection of ink through the sub-group-c nozzles of the nozzle group-2. In FIG. 25, the above formed images are indicated by shadowing with solid lines parallel to the paper sheet delivery direction. In this case, as shown in FIG. 25, on the recording medium sheet PC delivered as designed, the images are formed precisely in the range of the sub-regions 2-2-a and 2-2-c of the region II, whereas on the recording medium sheet PD, the formed images are dislocated forward from the sub-regions 2-2-a and 2-2-c in the paper sheet delivery direction since the front edge PDt of the recording medium sheet PD is placed behind the front edge PCt of the recording medium PC by the distance 2L1. In other words, the image to be formed in the sub-region 2-2-a of the region II on the recording medium sheet PD is shifted into the sub-region 4-4-b of the region II: the image to be formed in the sub-region 2-2-c of the region II is shifted into the sub-region 4-4-d of the region II. As the result, an image is not formed in the rear portions of the sub-regions 2-2-a and 2-2-c of the region II in the paper sheet delivery direction in the second passage printing.

The third ¼ rotation, subsequent to the above second ¼ rotation, of the delivery roller delivers the recording medium PD by a distance corresponding to the length of the arc from the point S3 to the point S4 on the perimeter. By this third delivery, as explained by reference to FIG. 19, the front edge PDt of the recording medium sheet PD comes to be placed behind (at the upstream side in the arrow-A direction of) the front edge PCt of the recording medium PC delivered as designed by a distance of 2L1 as shown in FIG. 26. On the recording medium sheet PD stopped in this state, the recording head is reciprocated once in the main scanning direction to form an image on the sub-region 3-3-b and the sub-region 3-3-d of the region III (third passage printing). The image on the sub-region 3-3-b is formed by ejection of ink through the sub-group-b nozzles of the nozzle group-3: The image on the sub-region 3-3-d is formed by ejection of ink through the sub-group-d nozzles of the nozzle group-3. In FIG. 26, the above formed images are indicated by shadowing with broken lines parallel to the paper sheet delivery direction. In this case, as shown in FIG. 26, on the recording medium sheet PC delivered as designed, the images are formed precisely in the range of the sub-regions 3-3-b and 3-3-d of the region III, whereas on the recording medium sheet PD, the formed images are dislocated forward from the sub-regions 3-3-b and 3-3-d in the paper sheet delivery direction since the front edge PDt of the recording medium sheet PD is placed behind the front edge PCt of the recording medium PC by the distance L1. In other words, the image to be formed in the sub-region 3-3-b of the region III on the recording medium sheet PD is shifted into the sub-region 1-1-c of the region III: the image to be formed in the sub-region 3-3-d of the region III is shifted out of the front edge PDt of the recording medium sheet PD. As the result, an image is not formed in the rear portions of the sub-regions 3-3-b and 3-3-d of the region III in the paper sheet delivery direction in the third passage printing.

The fourth ¼ rotation of the delivery roller, subsequent to the above rotation for delivery of the sheet by the distance d equal to the band breadth, delivers the recording medium sheet by a distance corresponding to the length of the arc from the point S4 to the point S5 on the perimeter of the delivery roller. By this fourth ¼ rotation, as explained by reference to FIG. 20, the front edge PDt of the recording medium sheet PD comes to be at the same position as the front edge PCt of the recording medium PC delivered as designed as shown in FIG. 27. On the recording medium sheet PD stopped in this state, the recording head is reciprocated once in the main scanning direction to form an image on the sub-regions 4-4-b and the sub-regions 4-4-d of the regions I and II (fourth passage printing). The images on the sub-regions 4-4-b are formed by ejection of the ink through the sub-group-b nozzles of the nozzle group-4: The images on the sub-regions 4-4-d are formed by ejection of the ink through the sub-group-d nozzles of the nozzle group-4. In FIG. 27, the above formed images are indicated by hatching with lines downward to the right. In this case, as shown in FIG. 27, both the recording medium sheet PD and on the recording medium sheet PC delivered as designed, the images are formed also precisely in the range of the sub-regions 4-4-b and 4-4-d of the regions I and II.

As described above, the delivery roller having the eccentric rotation axis D delivers the recording medium sheet PD by a stepwise delivery distance different from the delivery distance of the recording medium PC delivered as designed, causing in the sub-regions, a black streak (dark color portion by superposition of the images in the first to fourth passages) or a white streak (non-printed portion in which no image is formed from the first to fourth passages).

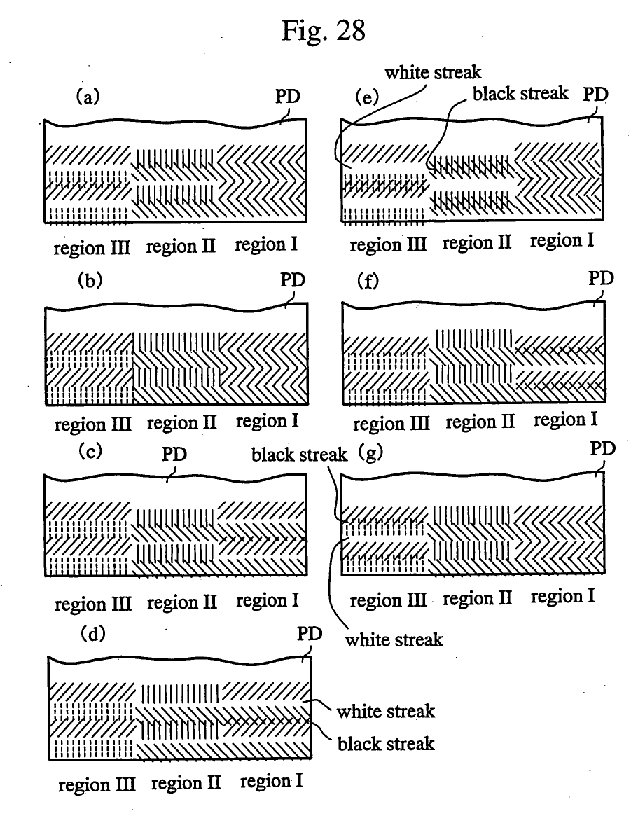

In the image formation shown in FIGS. 23-27, the delivery roller 24 (FIG. 1) is driven on the eccentric axis D by a delivery motor 120 (FIG. 2) stepwise by an angle of 90° to deliver the recording medium sheet PD and to observe deviation of the paper delivery distance. However, the cross-section of the delivery roller can be not a strict circle, but may be elliptic to have the diameter of the delivery roller varying with the measurement position. Further, the delivery distance by ¼ rotation can vary with replenishment of the recording medium, since the rotation starting position is not marked on the delivery roller. Furthermore, in actual inkjet type image-forming apparatus like the plotter 10, the perimeter length for one rotation (for the central angle of 360°) cannot always be an integral multiple of the one band breadth d, which can cause deviation of the start point of the stepwise rotation, causing deviation of the position of the image formation region in every rotation from the designed position. In such cases, the deviation of the paper sheet delivery cannot be compared at a constant stepwise rotation angle (e.g., 90°). Therefore, for confirmation of the deviation of the paper sheet delivery distance, printing is conducted by changing the central angle of the stepwise rotation by 1, for example from 86° to 92° on the three regions I, II, and III (FIG. 27, etc.). Such printing is explained by reference to FIG. 28.

FIG. 28 shows examples of images printed on the three regions I, II, and III for inspection for deviation of the paper sheet delivery distance by changing the central rotation angle of the stepwise rotation by 1° from 86° to 92°: the rotation angles of the central axis D being: (a), 86°; (b), 87°; (c), 88°; (d), 89°; (e), 90°; (f), 91°; and (g), 92° in FIG. 28.

The rotation angle of the delivery roller (stepping motor) can be changed by pressing a sheet delivery rate-controlling button (not shown in the drawing) on the control panel (FIG. 2) of the plotter 10 (FIG. 1). In this example, the rotation angle of the delivery roller is changed by 1° from 86° to 92° as described above by operating the paper sheet delivery adjustment button.

In printing the images for inspecting the deviation of the paper sheet delivery distance by changing the rotation angle of the delivery roller for one-step delivery, a black streak or a white streak is visually found obviously at some angle and not found at some angle in the ranges I, II, and III, as shown in drawings (a) to (g) in FIG. 28. In this example, at the rotation angle of 87° neither a black streak nor a white streak is found visually in all of the regions I, II, and III. Such a rotation angle at which neither the black streak nor the white streak is found is taken as a suitable rotation angle. Incidentally, the deviation of the paper sheet delivery distance (i.e., extent of occurrence of the black or white streak) depends on the extent of the deviation of the de-centered rotation axis D from the designed center axis C (position of the center axis D). Therefore, for forming the image having no black or white streak visually, the one-step rotation angle is adjusted by operating the paper sheet delivery control button of the control panel. The black or white streak may be detected by a sensor or the like in place of the visual examination.

According to the present invention, as explained above, printing is conducted on first sub-regions adjacent to each other in the paper sheet delivery direction in one band by plural passages, and further printing is conducted on second sub-regions adjacent to the first sub-regions in the main scanning direction perpendicular to the paper delivery direction by passage at least partly different from the passages for the first sub-regions. When the paper sheet delivery distance varies, a black or white streak is formed on the recording medium. To find the suitable delivery distance of the paper sheet for preventing the streak formation, the recording medium sheet is delivered at different levels of the sheet delivery distance, and the images formed in the first and second sub-regions are visually compared, and the sheet delivery distance not causing the black or white streak is selected as the optimum sheet delivery distance. Thereby the deviation of the delivery distance can be corrected even when the deviation of the sheet delivery distance (sheet delivery rate) is not constant.

1. An inkjet type image-forming apparatus which records an image on a recording medium sheet by ejecting an ink from a recording head held on a carriage by scanning with the recording head; delivering, after recording of one line of the image, a recording medium sheet by a prescribed distance; repeating the recording for formation of an entire image:
wherein the delivery distance of the recording medium sheet is controlled by using a mask for print-adjustment images at different intervals in the recording medium sheet delivery direction.

2. A method of adjusting a stepwise paper sheet delivery distance for delivering a recording paper sheet in an inkjet type image-forming apparatus, wherein the adjustment images formed with different intervals set forth in claim 1 are adjustment patterns printed by changing the paper sheet delivery distance, and the paper sheet delivery distance is adjusted based on the adjustment pattern.

3. A method for adjusting a paper sheet delivery distance in an inkjet type image-forming apparatus in which an image is formed in one band on a recording medium sheet by three or more multiple passage printing; wherein printing is conducted by passages on first plural sub-regions (sub-region group) aligned in the paper sheet delivery direction in the one band, and further printing is conducted, by passages different from the passage for the first plural sub-regions, on second plural sub-regions adjacent to the first plural sub-regions in the main scanning direction perpendicular to the paper sheet delivery direction; and the paper sheet delivery distance is adjusted based on the images formed in the first plural sub-regions and the second plural sub-regions.

4. The method for adjusting a paper sheet delivery distance according to claim 3, wherein, in printing on the first plural sub-regions by different passages, printing is conducted on one sub-region of the plural sub-regions by a passage preceding the passage for the adjacent other sub-region by two or more passages.

5. The method for adjusting a paper sheet delivery distance according to claim 3 or 4, wherein, in printing on the second plural sub-regions by different passages, printing is conducted on one of the sub-regions by a passage preceding the passage for the adjacent other sub-region by two or more passages.

6. The method for adjusting a paper sheet delivery distance according to claim 5, wherein, on the one sub-region of the first plural sub-regions, the printing is conducted by a passage different from the passage for printing on one sub-region of the second plural sub-regions.

7. The method for adjusting a paper sheet delivery distance according to claim 5 or 6, wherein on the other sub-region of the first plural sub-regions, the printing is conducted by a passage different from the passage for printing on the other sub-region of the second plural sub-regions.

8. The method for adjusting a paper sheet delivery distance according to any of claim 3 to 7, wherein the inkjet image-forming apparatus repeats an image-forming operation of delivering a recording medium sheet by a distance of one band breadth in the sheet delivery direction and stopping the sheet delivery, and forming an image by ejection of an ink from a recording head scanning in the scanning direction perpendicular to the sheet delivery direction.

9. The method for adjusting a paper sheet delivery distance according to any of claim 3 or 8, wherein the first plural sub-regions are formed by dividing the one band into three or more in the sheet delivery direction and are aligned in the sheet delivery direction.

10. The method for adjusting a paper sheet delivery distance according to claim 9, wherein the first plural sub-regions are formed by dividing equally the one band in the sheet delivery direction.

11. The method for adjusting a paper sheet delivery distance according to any of claims 3 to 10, wherein the second plural sub-regions are formed by dividing the one band into two or more in the main scanning direction, aligned in the main scanning direction.

12. The method for adjusting a paper sheet delivery distance according to claim 11, wherein the second plural sub-regions are formed by dividing equally the one band in the main scanning direction.

13. The method for adjusting a paper sheet delivery distance according to any of claims 3 to 12, wherein, in forming an image in the first and second plural sub-regions, the image is formed in the first and second plural sub-regions by delivering the recording medium sheet by changing the sheet delivery distance in several distance levels.

14. An inkjet type image-forming apparatus for forming an image in one band of a recording medium by multi-passage printing of three or more passages, wherein the apparatus is equipped with a recording head-controlling means which controls the recording head to conduct printing on the first plural sub-regions adjacent to each other in the recording medium delivery direction, and to conduct printing on the second plural sub-regions adjacent to the first plural sub-regions in the main scanning direction perpendicular to the recording medium sheet delivery direction by passages being different by at least one passage from the passage employed in the printing on the first sub-regions.

15. The inkjet type image-forming apparatus according to claim 14, wherein the recording head controlling means controls, in printing on the first plural sub-regions by different passages, the recording head to conduct printing on one sub-region of the plural sub-regions by a passage preceding the passage for the adjacent other sub-region by two or more passages.

16. The inkjet type image-forming apparatus according to claim 14 or 15, wherein the recording head controlling means controls, in printing on the second plural sub-regions by different passages, the recording head to conduct printing on one sub-region of the plural sub-regions by a passage preceding the passage for the adjacent other sub-regions by two or more passages.

17. The inkjet type image-forming apparatus according to claim 16, wherein the recording head controlling means controls the recording head to conduct printing, on one sub-region of the first plural sub-regions, by a passage different from the passage for printing on the one sub-region of the second plural sub-regions.

18. The inkjet type image-forming apparatus according to claim 16 or 17, wherein the recording head controlling means controls the recording head to conduct printing, on the other sub-region of the first plural sub-regions, by a passage different from the passage for printing on the other sub-region of the second plural sub-regions.

19. The inkjet type image-forming apparatus according to any of claims 14 to 18, wherein the first plural sub-regions are formed by dividing the one band into three or more in the sheet delivery direction and are aligned in the sheet delivery direction.

20. The inkjet type image-forming apparatus according to claim 19, wherein the first plural sub-regions are formed by dividing equally the one band in the sheet delivery direction.

21. The inkjet type image-forming apparatus according to any of claims of 14 to 20, wherein the second plural sub-regions are formed by dividing the one band into two or more in the main scanning direction, aligned in the main scanning direction.

22. The inkjet type image-forming apparatus according to claim 21, wherein the second plural sub-regions are formed by dividing equally the one band in the main-scanning direction.

23. The inkjet type image-forming apparatus according to any of claims 14 to 22, wherein, in forming an image in the first and second plural sub-regions, the image is formed in the first and second plural sub-regions by delivering the recording medium sheet by changing the sheet delivery distance in several distance levels.
